(19) United States
(12) Patent Application Publication
(10) Pub. No.: US 2026/0320725 A1
(43) Pub. Date: Oct. 15, 2026

(54) METHOD AND SYSTEM FOR SECURE CARPOOLING WITH DYNAMIC GROUP-BASED MATCHING

(71) Applicant: Lets Carpool Corp., Wilmington, DE (US)

(72) Inventors: Michael Jonathan Cooper, Passaic, NJ (US); David Alan LeVine, Sarasota, FL (US)

(73) Assignee: Lets Carpool Corp., Wilmington, DE (US)

(21) Appl. No.: 19/175,643

(22) Filed: Apr. 10, 2025

(51) Int. Cl. G06Q 50/43; H04L 9/40

(52) U.S. Cl. CPC G06Q 50/43

(57) ABSTRACT

In an embodiment, a method for secure carpooling is disclosed. The method is performed by at least one processor including hardware. The method includes receiving, over a secure communication channel, a carpool request from a first user to a second user. The first user has an existing carpooling connection with the second user. The method further includes retrieving, from a user database, data for the first user and the second user, calculating a trust score for the first user and the second user using the data, the trust score being private and calculated based on a weighted formula combining one or more trust factors, and determining that the calculated trust score exceeds a minimum threshold value. The method further includes establishing a carpool between the first user and the second user if the calculated trust score exceeds the minimum threshold value.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO RELATED APPLICATIONS

The present application is related to the following application, which is incorporated by reference herein in its entirety:

### BACKGROUND

This application relates to the field of transportation management and carpooling, and in particular, methods and systems for facilitating secure carpooling services with dynamic group-based matching.

Since the launch of Uber® in 2009, ride-sharing applications have soared in popularity due to the numerous advantages they provide over traditional transportation methods. Ride-sharing applications allow users to request a ride with a few taps on their phone, eliminating the need to hail a taxi or wait at a bus stop. These applications offer door-to-door service, making transportation more convenient, especially in areas with limited public transportation options. In many cases, ride-sharing and carpooling services are more affordable than traditional transportation methods such as taxis and limousines, particularly for shorter distances. Ride-sharing and carpooling services can increase mobility for individuals who may not have access to personal vehicles or rely on public transportation, including seniors, people with disabilities, and low-income populations.

Although ride-sharing services like Uber® and Lyft® have revolutionized personal transportation, significant challenges persist in creating truly secure and socially connected carpooling experiences. While these platforms have introduced various safety features and convenience mechanisms, existing carpooling technologies focus primarily on real-time scheduling, network-wide ride coordination, and algorithm-driven matching. Their fundamental approach to trust and group coordination remains limited.

For example, Uber® and similar on-demand ride-sharing services rely primarily on post-ride, reactive rating systems and basic identity verification. Other safety risks such services present include privacy vulnerabilities in location sharing and tracking. Thus, there is a need for an improved method for secure carpooling based on explicit, mutual trust relationships that addresses privacy and security concerns. The present invention creates a comprehensive solution that addresses the fundamental limitations of existing carpooling platforms while introducing new capabilities for secure, socially-connected transportation coordination.

### SUMMARY

In an embodiment, non-transitory computer-readable media comprising program code that when executed by a programmable processor causes execution of a method for secure carpooling is disclosed. The computer readable media comprises computer program code for receiving, over a secure communication channel, a carpool request from a first user to a second user. The first user has an existing carpooling connection with the second user. The computer readable media further comprises computer program code for retrieving, from a user database, data for the first user and the second user and calculating a trust score for the first user and the second user using the data. The trust score is private and is calculated based on a weighted formula combining one or more trust factors.

The computer readable media further comprises computer program code for determining that the calculated trust score exceeds a minimum threshold value. The computer readable media further comprises computer program code for establishing a carpool between the first user and the second user if the calculated trust score exceeds the minimum threshold value.

According to an embodiment, the one or more trust factors may comprise a connection frequency analysis, group membership volatility, event participation patterns, and historical verification irregularities. Each of the one or more trust factors may be assigned a relative weight value. The computer readable media may further comprise computer program code for continuously updating the data stored in the user database, retrieving the updated data, and recalculating the trust score in response to a change in the updated data or an elapsing of a predetermined amount of time.

In an embodiment, the carpooling connection may be established using end-to-end data encryption. The computer readable media may further comprise computer program code for identifying, by an administrative trust validation module, a security threat using real-time usage analytics and anomaly detection algorithms and mitigating the identified security threat according to a predefined response protocol.

In an embodiment, the computer readable media may further comprise computer program code for calculating a trust score for a driver, determining that the calculated trust score exceeds a minimum threshold value, and establishing a carpooling connection between the first user, the second user, and the driver if the calculated trust score exceeds the minimum threshold value. The trust score may be calculated based on a weighted formula combining one or more driver trust factors.

In an embodiment, the computer readable media may comprise computer program code for creating, by a group management module using real-time geofencing, location-based groups. The computer readable media may further comprise computer program code for providing, by the group management module, access to a given location-based group based on a current location of a user, displaying information regarding the given location-based group to the user, and storing the location-based groups in a groups database. The information may comprise a name of and an icon for the given location-based group. The computer readable media may further comprise computer program code for receiving, by the group management module, updated geofencing data, and updating membership of the location-based groups based on the updated geofencing data.

In an embodiment, the computer readable media may comprise computer program code for creating, by a group management module using real-time user activity data, interest-based groups. The computer readable media may further comprise computer program code for providing, by the group management module, access to a given interest-based group based on an affiliation of a user, displaying information regarding the given interest-based group to the user, and storing the interest-based groups in a groups database. The information may comprise a name of and an icon for the given interest-based group. The computer readable media may further comprise computer program code for receiving, by the group management module, updated user activity data and updating membership of the interest-based groups based on the updated user activity data.

The computer readable media may further comprise computer program code for implementing a driver approval mechanism wherein a driver provides an approval to establish a carpooling connection with the first user and the second user. The computer readable media may further comprise computer program code for implementing a mutual approval mechanism wherein the first user and the second user each provide an approval to establish the carpooling connection. The computer readable media may further comprise computer program code for storing carpooling connection data in a connections database, retrieving the carpooling connection data from the connections database, and using the retrieved carpooling connection data to establish a second carpooling connection in response to a connection request between the first user and the second user.

In an embodiment, a method for secure carpooling is disclosed. The method is performed by at least one processor comprising hardware. The method comprises receiving, over a secure communication channel, a carpool request from a first user to a second user. The first user has an existing carpooling connection with the second user. The method further comprises retrieving, from a user database, data for the first user and the second user and calculating a trust score for the first user and the second user using the data. The trust score is private and is calculated based on a weighted formula combining one or more trust factors.

The method further comprises determining that the calculated trust score exceeds a minimum threshold value. The method further comprises establishing a carpool between the first user and the second user if the calculated trust score exceeds the minimum threshold value. In an embodiment, the one or more trust factors may comprise a connection frequency analysis, group membership volatility, event participation patterns, and historical verification irregularities. Each of the one or more trust factors may be assigned a relative weight value.

According to an embodiment, the method may further comprise continuously updating the data stored in the user database, retrieving the updated data, and recalculating the trust score in response to a change in the updated data or an elapsing of a predetermined amount of time. The method may further comprise identifying, by an administrative trust validation module, a security threat using real-time usage analytics and anomaly detection algorithms and mitigating the identified security threat according to a predefined response protocol.

According to an embodiment, the method may further comprise calculating a trust score for a driver, determining that the calculated trust score exceeds a minimum threshold value, and establishing a carpooling connection between the first user, the second user, and the driver if the calculated trust score exceeds the minimum threshold values. The trust score may be calculated based on a weighted formula combining one or more driver trust factors. The method may further comprise implementing a driver approval mechanism wherein a driver provides an approval to establish a carpooling connection with the first user and the second user. In an embodiment, the method may further comprise implementing a mutual approval mechanism wherein the first user and the second user each provide an approval to establish the carpooling connection.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIGS. 1A and 1B are diagrams of core system components of a system architecture according to an embodiment.

FIG. 2 is a diagram of request processing components according to an embodiment.

FIG. 3 is a flow diagram of an example request initiation process of a connection management process according to an embodiment.

FIG. 4 is a flow diagram of an example approval process of a connection management process according to an embodiment.

FIG. 5 is a diagram of ride management components according to an embodiment.

FIG. 6 is a flow diagram of an example ride creation process of a ride creation and participation process according to an embodiment.

FIG. 7 is a flow diagram of an example participation management process of a ride creation and participation process according to an embodiment.

FIG. 8 is a diagram of group management components according to an embodiment.

FIG. 9 is a flow diagram of an example location-based discovery process of a group formation and discovery process according to an embodiment.

FIG. 10 is a flow diagram of an example interest-based matching process of a group formation and discovery process according to an embodiment.

FIG. 11 is a diagram of a user interface component architecture according to an embodiment.

FIG. 12 is a flow diagram of an example ride management process according to an embodiment.

FIG. 13 is a diagram of data structure components of a database schema according to an embodiment.

FIG. 14 is a diagram of security architecture components of a security implementation according to an embodiment.

FIG. 15 is a diagram of administrative monitoring system components according to an embodiment.

FIG. 16 is a diagram of payment flow components of a payment processing architecture according to an embodiment.

FIG. 17 is a flow diagram of an example payment processing transaction according to an embodiment.

FIG. 18 is a diagram of input processing components of a trust score calculation framework according to an embodiment.

FIG. 19 is a diagram of a calculation engine of a trust score calculation framework according to an embodiment.

FIG. 20 is a flow diagram of an example data collection computational process of a trust score calculation framework according to an embodiment.

FIG. 21 is a flow diagram of an example score calculation and update process of a trust score calculation framework according to an embodiment.

FIG. 22 is a flow diagram of an example method for secure carpooling according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

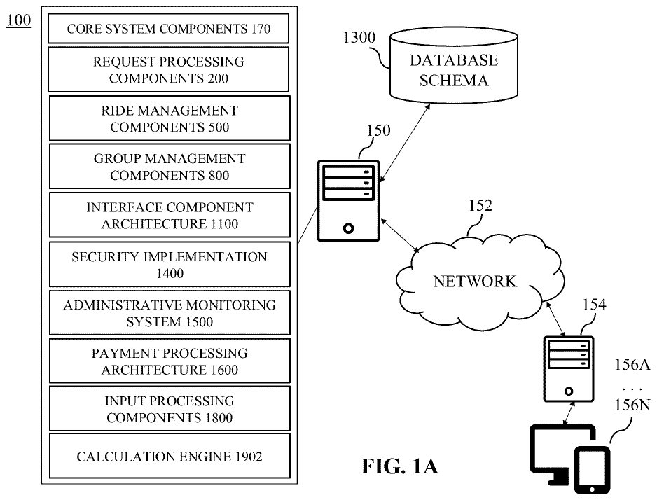

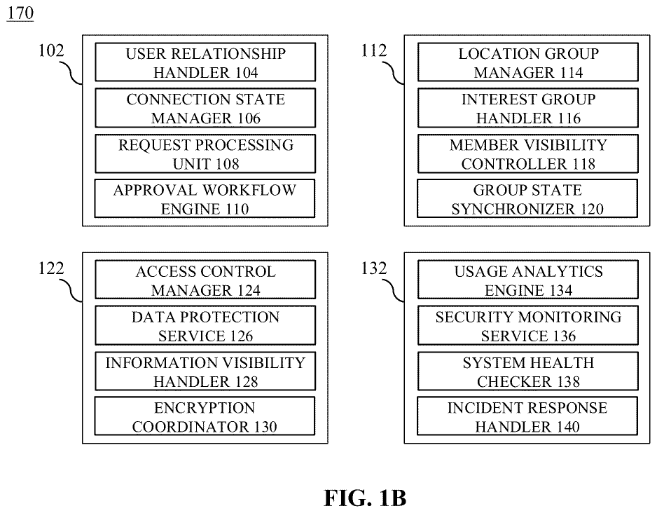

With reference to FIGS. 1A and 1B, a system 100 is disclosed in accordance with embodiments of the invention that implements a connection-based framework for carpooling. System 100 is configured to facilitate carpooling with dynamic route optimization, multi-passenger transportation coordination, and event-based transportation management. System 100 is designed to be scalable, maintainable, and adaptable to changing needs while maintaining high security and performance standards.

System 100 comprises a server 150 configured to store core system components 170, request processing components 200, ride management components 500, group management components 800, interface component architecture 1100, security implementation 1400, administrative monitoring system 1500, payment processing architecture 1600, input processing components 1800, and calculation engine 1902. Network 152 is configured to connect server 150 with application programming interface (“API”) server 154 to access API connections 156A-156N. System 100 further comprises database schema 1300.

The present invention combines the elements of social trust, explicit connection-based access control, and robust privacy preservation. By building ride-sharing networks based on explicit, mutual trust relationships, system 100 ensures that all participants are pre-validated and connected through user-controlled, dynamic groups. This approach not only overcomes the limitations of generalized ride management systems but also addresses privacy and security concerns. Unlike systems that rely on generic authentication or automated matching, system 100 requires direct, mutual ride-sharing connections. This ensures that participation is limited to users who have established trust relationships, effectively reducing the risk of unauthorized access.

Whereas conventional systems use static or algorithm-driven scheduling, system 100 forms ride-sharing groups on-demand based on both geographic proximity and shared interests. This real-time, context-aware matching ensures responsiveness to immediate user needs. System 100 further incorporates a dedicated privacy control layer alongside an invisible, administrative security framework that monitors behavior in the background. By enforcing end-to-end encryption and minimizing public data exposure, system 100 offers robust protection against fraud and unauthorized data sharing.

The present invention enables users to maintain granular control over what personal information is shared. Unlike traditional ride-sharing systems that rely on broad data collection and centralized management, system 100 empowers individuals to manage their own connection networks and privacy settings. By integrating these key innovations, the present invention delivers a secure, socially driven ride-sharing experience that clearly surpasses the limitations of conventional transportation systems and related trust-based methodologies.

According to an embodiment, system 100 operates through a mobile application interface (i.e., API connections 156A-156N), supported by a secure cloud-based backend infrastructure. In an embodiment, system 100 is accessible on a client device that may comprise computing devices and may vary in terms of capabilities or features, for example, a cell phone, smart phone, tablet computer, laptop, and in-dash car computer, or the like. The client device may be web-enabled and may include one or more physical or virtual keyboards, mass storage, a webcam, a speaker, one or more accelerometers, one or more gyroscopes, global positioning system (GPS) or other location identifying type capability, and a display with a high degree of functionality, such as a touch-sensitive color 2D or 3D display.

The following terms as used in the description of specific embodiments herein should generally be understood as follows, with variations on that as would be understood by those of skill in the art:
A Carpooling Connection generally refers to an explicit mutual agreement between users indicating willingness to share rides together, distinct from typical social media connections or friendships.
A Connection Request generally refers to a formal invitation from one user to another to establish a carpooling connection, requiring mutual approval.
A Connection Level generally refers to the relationship between users (e.g., direct connection, connection through a mutual passenger, group-based discovery).
A Dynamic Group generally refers to a collection of users whose membership and boundaries can change based on location, time, or event participation, where members can discover potential carpooling connections.
A Geofenced Group generally refers to a group automatically created and managed based on geographic boundaries and user presence within those boundaries, facilitating local connection discovery.
An Interest-Based Group generally refers to a group formed around shared interests, events, or affiliations, enabling connection discovery among users with common activities or destinations.
A Temporary Group generally refers to a time-limited group created for specific events or purposes, with automatic expiration and connection discovery limited to event duration.
A Public Profile generally refers to the minimal user information (name and icon only) visible to other users before establishing a carpooling connection.
Connection Privacy generally refers to settings that control what additional information becomes visible after establishing a carpooling connection.
Group Privacy generally refers to controls determining what user information is visible within specific groups and how users can be discovered.
A Connected Ride generally refers to a ride shared exclusively among users who have established carpooling connections, either directly with the driver or through connected passengers.
A Passenger Invitation generally refers to the ability for a connected passenger to invite their own connections to join a ride, subject to driver approval.
A Driver Approval generally refers to the required authorization from a driver for any user to join their ride, whether directly connected or invited by a passenger.
A Connection Verification generally refers to the process of validating and maintaining carpooling connections between users.
Administrative Monitoring generally refers to a background system processes that analyze usage patterns and maintain platform integrity without affecting user connections.
A Privacy Control Layer generally refers to the system component that manages and enforces user privacy settings across all interactions and data exchanges.
A Connection Management System generally refers to the technical infrastructure handling carpooling connection requests, approvals, and maintenance.
A Group Discovery Engine generally refers to the system component responsible for managing user discovery through location-based and interest-based groups while maintaining privacy controls.
A Ride Coordination System generally refers to the component that manages ride creation, invitation, and participation based on established connections and driver approvals.

The mobile application may comprise native applications including iOS™ (Swift-based implementation), Android™ (Kotlin™-based implementation), and shared business logic using Kotlin Multiplatform™. Key features of the mobile application include background location tracking, push notification system, offline capabilities, and local data encryption.

In an embodiment, system 100 comprises a cloud infrastructure supported by Google Cloud Platform™ (“GCP”) as its primary platform. System 100 may utilize Cloud Run for containerized microservices, Cloud Spanner™ for distributed database, Cloud Functions for serverless operations, and Cloud Storage™ for media and document storage. System 100 may operate through a mobile application interface with a microservices-based design comprising an Authentication Service, Group Management Service, Ride Matching Service, and Payment Processing Service. The application architecture may further comprise an event-driven architecture using Pub/Sub (publish/subscribe), Redis™ for caching and real-time operations, and Elasticsearch™ for search functionality.

System 100 is configured to implement social networking technology and social validation mechanisms to create trust-based social connections between users. System 100 is further configured for group formation and management and interest-based community building. According to an embodiment, system 100 is configured to interface with existing social networking platforms such as Facebook®, Instagram®, Snapchat®, X®, LinkedIn®, Threads®, WhatsApp, and TikTok®. System 100 is further configured to integrate with existing transportation and carpooling applications and services, including but not limited to, Uber®, Lyft®, Cabify®, Bolt®, and Curb®. According to an embodiment, system 100 is further configured for third-party platform integration including map service integration (e.g., Google Maps® embedding, Waze® navigation integration, Apple Maps® compatibility, and OpenStreetMap® implementation), social platform connectivity (e.g., social media authentication, professional network verification, event platform synchronization, and calendar integration), and enterprise software integration (e.g., HR system connections, corporate directory services, expense management systems, and meeting scheduler integration).

The present invention is configured to function as a mobile application with location-aware services, real-time user interaction, mobile payment processing, and push notification systems. Location-based services of the mobile application comprise geofencing technology, geographic boundary management, location tracking and privacy, and proximity-based matching between users. Security and authentication features of the mobile application include identity verification systems, multi-factor authentication, privacy protection mechanisms, and trust scoring algorithms. The mobile application is further configured for event management utilizing schedule coordination, attendance verification, group transportation planning, and venue-specific logistics. The present invention is further configured for payment processing comprising cost-sharing calculations, group payment management, digital wallet integration, and transaction security.

The present invention specifically addresses the intersection of the above-mentioned technical fields to create a comprehensive solution for secure, socially-validated carpooling that leverages modern mobile and cloud computing capabilities while maintaining user privacy and security. The present invention offers a comprehensive solution that combines social trust mechanisms, dynamic group management, and flexible carpooling capabilities while maintaining robust privacy and security controls.

According to an embodiment, system 100 is configured for mobile platform extensions such as wearable device integration with smart device features including location tracking, ride notifications, quick response actions, and health data integration. System 100 may be further configured for vehicle integration with connected car features such as vehicle verification, automated check-in, route optimization, and fuel cost calculations.

Core system components 170 (FIG. 1B) comprise connection management service 102, group discovery engine 112, privacy control layer 122, and administrative monitor 132. In an embodiment, social trust operates as the core mechanism of system 100. Connection management service 102 comprises user relationship handler 104, connection state manager 106, request processing unit 108, and approval workflow engine 110. User relationship handler 104 is configured to maintain encrypted connection relationships between users in a connection database, for example, a distributed graph database. Connection state manager 106 is configured to synchronize real-time connection states across nodes, and to process atomic transactions for connection updates. Request processing unit 108 is configured to validate mutual connection requests, for example, cryptographically or through various digital signature algorithms such as an elliptic curve digital signature algorithm (“ECDSA”) with secp256kl curve.

According to an embodiment, ride participation requires explicit user-to-user connections indicating willingness to share rides. Connections are based on mutual trust and manual initiation between users. This ensures carpooling safety through real social connections rather than traditional rating systems. Once a connection is established between users, the connection is persistent until either user removes it, or one/both users' trust score falls below a predetermined minimum threshold. Users are not able to request a carpool with each other unless they are already connected. System 100 is configured to check for a connection between users and validate the users' trust scores to determine the users' carpool eligibility.

In an embodiment, users may only join rides through direct connection with the driver. In another embodiment, users may only join rides through invitation from connected passengers, subject to driver approval.

In an embodiment, ride management components 500 may be configured to verify that each user/participant has an active carpooling connection with the driver through a mutual approval process prior to joining the ride. Ride management components 500 may be configured to implement a driver override mechanism that allows the driver to modify, approve, or reject ride participation requests on a per-instance basis. Ride management components 500 may be configured to dynamically update ride details in real time, wherein any changes in user status, pickup arrangements, or ride route modifications are communicated to all involved parties through a secure notification system. In an embodiment, ride participation may be permitted only if the user is within a predefined geographic boundary (as verified via geofencing) relevant to the ride's origin or destination. Implementing privacy controls may comprise encrypting user information during transmission and storage using industry-standard encryption protocols.

By requiring verified connections, connection management service 102 provides practical benefits including reducing unauthorized ride access, thereby enabling natural community growth through trusted relationships. Connection management service 102 is further configured to prevent connection spoofing through cryptographic verification and to maintain system integrity during high-volume operations. Connection management service 102 facilitates explicit carpooling connections between users, manages connection requests and approvals, maintains connection relationships, and enables passenger-initiated invitations to their connections. Primary connection methods include direct connection requests between users, group-based discovery and connection, and event-based connection opportunities. Connections are validated through mutual approval between users, explicit carpooling consent, and group membership verification. Connection management features of the present invention include connection status tracking, connection history maintenance, and privacy-preserving connection discovery.

In an embodiment, the core functionality of connection management service 102 comprises connection request processing and validation, mutual approval workflow management, connection relationship maintenance, and connection-based access control. Implementation features include real-time connection status updates, a connection-based notification system, privacy-preserving connection discovery, and group context preservation. Connection data structures of connection management schema 1302 comprise connection relationship graphs, connection status tracking, connection history records, and privacy preference mapping.

According to an embodiment, connection management service 102 is configured for primary authentication (e.g., facial recognition using Google Cloud Vision API, document verification through third-party KYC service, phone number verification via SMS, and email domain validation), connection verification (e.g., mutual approval workflow, group-based discovery controls, privacy-preserving connection requests, and connection history tracking), and administrative monitoring (e.g., real-time behavior analysis, ride pattern monitoring, group interaction tracking, and report handling system).

System 100 is configured to enable users to discover potential carpooling partners through location-based and interest-based groups while maintaining strict privacy controls. Group discovery engine 112 comprises location group manager 114, interest group handler 116, member visibility controller 118, and group state synchronizer 120. Location group manager 114 is configured to utilize polygon-based geofencing with real-time boundary adjustment, which may be implemented using a Voronoi diagram-based algorithm that dynamically adapts to user density and activity patterns. Location group manager 114 is further configured to implement optimized spatial indexing for location queries. Member visibility controller 118 is configured to implement event-driven architecture for membership updates. Group state synchronizer 120 is configured to implement a distributed cache system for group membership state.

According to an embodiment, group discovery engine 112 provides practical benefits such as reducing server load through distributed caching, enabling efficient local community formation, supporting intermediate group updates for time-sensitive events, and maintaining performance with a growing user base. Group discovery engine 112 supports both (1) location-based groups defined by geofenced boundaries, and (2) interest-based groups centered around specific events or common interests, while maintaining minimal public user information (name and icon only).

System 100 is configured to maintain minimal public user information and to implement administrative trust validation for platform integrity. Privacy control layer 122 comprises access control manager 124, data protection service 126, information visibility handler 128, and encryption coordinator 130. Access control manager 124 is configured to maintain role-based access control with granular permissions. Data protection service 126 is configured to prevent unauthorized data access during transmission. Information visibility handler 128 is configured to enable precise control over information sharing. Encryption coordinator 130 is configured to provide end-to-end encryption for data transmission, including the establishment of carpooling connections. Encryption may be implemented using encryption standards such as AES-256 in GCM (“Galois/Counter Mode”) to ensure both confidentiality and integrity.

According to an embodiment, access control manager 124 enables user data rights management via a self-service data access portal with automated data export functionality, historical data review capabilities, connection history transparency, and group membership records. Access control manager 124 further comprises a data deletion framework for secure data erasure procedures, such as cryptographic erasure and overwriting, to ensure permanent deletion of user data upon account termination. The data deletion framework further implements account deletion protocols, data retention policies, automated data purging, backup removal procedures, and third-party data removal.

Data protection service 126 implements a regulatory compliance framework wherein regional privacy laws are addressed through specific compliance measures such as data subject rights management, data localization, and privacy by design principles. General Data Protection Regulation (′GDPR″) compliance mechanisms include explicit user consent management, right to data access and deletion, data portability support, privacy by design implementation, and data minimization protocols. Data protection service 126 also implements compliance features of the California Consumer Privacy Act (“CCPA”), adherence mechanisms for Canada's Personal Information Protection and Electronic Documents Act (“PIPEDA”), and compliance support for Brazil's General Data Protection Law (“LGPD”), as well as regional data storage requirements and cross-border data transfer protocols.

According to an embodiment, a compliance monitoring system utilizes automated tools and regular audits to track and verify compliance with relevant privacy regulations, including data access logs and consent management records. The compliance monitoring system is configured to perform automated compliance checks with regular privacy audits, policy enforcement verification, consent management tracking, data handling validation, and access control monitoring. The compliance monitoring system is further configured for documentation and reporting by implementing compliance audit trails, privacy impact assessments, regular compliance reports, incident response documentation, and user consent records.

According to an embodiment, privacy control layer 122 is configured with a focus on data minimization by engaging in essential-only data collection, temporary data storage protocols, automated data expiration, purpose-specific retention, and anonymous analytics processing. Privacy control layer 122 implements data localization through regional data centers, ensuring compliance with data residency requirements while minimizing cross-border data transfers. Data localization further entails regional data center deployment, geographic data boundaries, local processing requirements, cross-region synchronization, and jurisdiction-based access controls.

Privacy control layer 122 provides practical benefits such as ensuring immediate privacy setting enforcement and maintaining data consistency during system failures. According to an embodiment, privacy control layer 122 is further configured to enforce real-time privacy settings through distributed nodes, and to provide atomic privacy updates with rollback capability. Privacy control layer 122 ensures user privacy is protected by implementing features such as private connection management and secure interaction history. Furthermore, the present invention does not employ public metrics or comparative rankings. Privacy control layer 122 manages minimal public user information, connection-based information access, personal data protection, and group-specific visibility rules.

According to an embodiment, privacy control layer 122 implements additional data privacy and security specifications such as an authentication and authorization framework. Privacy control layer 122 may implement a multi-factor authentication system which presents users with cryptographic challenge-response for primary verification, time-based OTP (RFC 6238) for secondary verification, FIDO2-compliant biometric validation, and browser/device signature analysis for device fingerprinting. Privacy control layer 122 may further implement token management with JWT with RS256 signature algorithm, 15-minute access token expiration, 7-day refresh token with rotation, and secure token storage using HttpOnly cookies.

In an embodiment, privacy control layer 122 implements additional verification methods for biometric authentication, including fingerprint recognition, voice authentication, retinal scanning, and behavioral biometrics. Privacy control layer 122 may also implement blockchain-based, decentralized identity verification such as self-sovereign identity, distributed trust networks, immutable authentication records, and cross-platform identity portability.

Privacy control layer 122, privacy control module 522, privacy management center 1132, and privacy protection system 1412 ensure user data protection and selective information sharing. These components implement an information visibility framework wherein public information is limited to username, profile icon, and group membership(s). Connected users may have visibility access to shared ride histories, shared group activities, and contact preferences. Usage analytics engines 1502 and 134 engage in administrative data collection, the data comprising usage patterns, security metrics, and system integrity data.

Access control manager 124, information access managers 524 and 1108, access control engine 1410 and information access controller 1416 are configured to implement connection-based permissions (e.g., explicit sharing approval, temporary ride access, group-specific visibility) and data protection (e.g., end-to-end encryption, secure storage, access logging, regular auditing).

According to an embodiment, encryption coordinator 130 implements AES-256 encryption for all sensitive user data, RSA-4096 for key encryption, and 30-day automated key rotation. Furthermore, Hardware Security Module (“HSM”) Integration provides secure key management and cryptographic operations, protecting sensitive user data and cryptographic keys. Encryption coordinator 130 may implement features for transmission security, such as TLS 1.3 with Perfect Forward Secrecy, ECDSA with P-256 for signatures, and real-time certificate validation. Encryption coordinator 130 may further implement certificate pinning for API endpoints by associating a specific cryptographic certificate with the server's domain name, preventing man-in-the-middle attacks and ensuring secure communication.

Administrative monitor 132 comprises usage analytics engine 134, security monitoring service 136, system health checker 138, and incident response handler 140. Administrative monitor 132 is configured as a distributed state machine for user permission management, which may be implemented using consensus algorithms such as Raft to ensure consistent and fault-tolerant state replication across nodes. According to an embodiment, administrative monitor 132 is further configured for real-time event processing for setting updates, cached permission verification for performance, and atomic transaction processing for control changes. Administrative monitor 132 utilizes administrative tools such as background pattern monitoring, automated threat detection, invisible security scoring, and a proactive intervention system. Administrative monitor 132 facilitates usage pattern analysis, security concern identification, system integrity maintenance, and proactive issue prevention.

Administrative monitor 132 provides practical benefits such as providing an immediate response to permission changes, reducing server load through smart-caching, preventing race conditions in multi-user scenarios, and maintaining system responsiveness at scale. The administrative monitoring approach of administrative monitor 132 operates invisibly to users, with no public rating or scoring displays. The focus of administrative monitor 132 is on threat detection and prevention, with an emphasis on natural connection building between users.

Administrative monitor 132 and administrative monitoring system 1500 are configured for background processes including usage pattern analysis, security anomaly detection, system integrity verification, and performance monitoring. Administrative monitor 132 and administrative monitoring system 1500 implement management tools including issue investigation interfaces, pattern recognition algorithms, preventive measure implementation, and system health dashboards. Administrative monitor 132 and administrative monitoring system 1500 are configured to collect data including anonymized usage metrics, security event logging, performance statistics, and system diagnostics.

The user experience of the present invention is protected by non-competitive scoring mechanisms, equal connection opportunities, a privacy-first approach to relationships, and an emphasis on authentic interactions. Traditional carpooling and ride-sharing platforms implement public rating systems for security purposes. In contrast, the present invention utilizes background security monitoring wherein user behavior is not quantified for display. This allows a focus on building connections rather than rankings.

According to an embodiment, system 100 comprises trust-based security architecture. The trust-based security architecture comprises a distributed ledger maintaining encrypted connection states, which may be implemented using Hyperledger Fabric technology, providing a secure and tamper-proof record of user relationships. System 100 is further configured for atomic transactions for connection updates, multi-node validation for state changes, real-time synchronization across regions, and cryptographic proof of connection validity.

Implementation of the trust-based security architecture provides measurable benefits such as reducing unauthorized access attempts, achieving sub-second connection validation, supporting scalable concurrent connections per region, and maintaining consistency across distributed nodes with minimum latency. A social-trust framework also empowers users to build their own trusted carpooling networks, enables direct connection-based ride sharing, facilitates organic group formation and community building, and supports event-based temporary connections. Background security monitoring operates invisibly to protect these social interactions.

According to an embodiment, system 100 is configured to implement a system operation flow process. The system operation flow process comprises real-time state management (by state management system 210), cross-component communication, data synchronization (by synchronization service 240), and security protocol execution.

According to an embodiment, privacy control layer 122 comprises a scalable privacy control system. The scalable privacy control system comprises a multi-tier caching architecture, which may be implemented utilizing Redis for in-memory data storage and Memcached for distributed caching of frequently accessed user and group data. System 100 is further configured for local device caching for frequent queries and intelligent cache invalidation. System 100 further comprises regional edge caches for group data and a global cache coordination system.

Implementation of the scalable privacy control system provides measurable benefits by handling scalable permission updates per second, reducing database load, achieving millisecond privacy setting enforcement, and supporting millions of concurrent users. User-controlled privacy enables users to manage their own connection networks. Context-aware visibility settings enable users to maintain granular control over personal information sharing. User-defined group participation is supported by backend security protocols.

According to an embodiment, group discovery engine 112 is configured for distributed group management. Group discovery engine 112 comprises a hierarchical group data structure, which may be implemented as a tree-like structure where each node represents a group and child nodes represent subgroups or individual users, enabling efficient search and management of group memberships. The hierarchical group data structure is configured for geospatial indexing for location groups, B-tree indexing for membership queries, real-time boundary computation, and event-driven state updates.

Group discovery engine 112 and local group engine 802 are configured for location-based implementation including dynamic geofence management, member discovery controls, privacy-preserving location services, and temporary group formation. Group discovery engine 112 and interest group handler 812 are configured for interest-based implementation including event-driven group creation, affiliation verification, member visibility controls, and cross-group coordination. Discovery system 822 implements privacy controls including minimal information display, group-specific visibility rules, member discovery limitations, and data access restrictions.

Implementation of the hierarchical group data structure provides measurable benefits by processing scalable group updates per second, supporting scalable concurrent group members, achieving sub-second group formation time, and maintaining sub-second query response times. Community-based discovery of the present invention enables location and interest-based group formation, natural connection building through shared contexts, user-driven group creation and management, and flexible event-based networking which is protected by invisible security monitoring.

According to an embodiment, security monitoring service 136 is configured for real-time security monitoring. Security monitoring service 136 comprises stream processing architecture, which may be implemented utilizing Apache Kafka for real-time data ingestion and Apache Flink for distributed stream processing and analysis of user activity and security events. The stream processing architecture comprises a real-time pattern analysis engine, a multi-stage alert pipeline, and an automated response system. The stream processing architecture is further configured for distributed anomaly detection and provides measurable benefits by detecting security threats within a sub-second response time, processing scalable event streams per second, achieving near-zero false positives, and reducing false positives by 90%.

According to an embodiment, system 100 comprises a performance optimization framework. The performance optimization framework comprises a multi-level optimization system, which may be implemented using a combination of caching, load balancing, and resource monitoring to optimize system performance. Implementation of the performance optimization framework provides measurable benefits by maintaining a sub-second average response time, supporting scalable daily active users per region, achieving near-zero system downtime, and optimizing resource usage.

The performance optimization framework further comprises a query optimization engine employing cost-based optimization techniques, including query rewriting and index selection, to improve database query performance. The performance optimization framework is configured for adaptive load balancing using a combination of round-robin and least connections algorithms, dynamically distributing traffic across server nodes based on real-time load conditions. The performance optimization framework is further configured to monitor resource utilization. The performance optimization framework implements automatic scaling triggers based on CPU utilization, memory usage, and request latency metrics, automatically adjusting the number of server instances to maintain optimal performance.

The present invention is configured to address several shortcomings of existing ride-sharing and carpooling systems. For example, existing systems rely on basic identity checks and post-ride ratings, which fail to prevent unauthorized ride access and potential security threats. According to an embodiment, system 100 addresses such challenges in identity verification by implementing a multi-layer verification system that requires an establishment of explicit mutual connection (e.g., between users and/or drivers) before ride sharing. System 100 is further configured to validate connections through cryptographic protocols, enforce driver-mediated approval workflows, and maintain verifiable connection graphs in a distributed database. This reduces unauthorized ride access attempts through connection verification.

In an embodiment, ride participation rules may include direct driver connections. For example, users may be required to connect with a driver to join a ride (if they are not invited by another user/participant with whom they already have a connection). In another example, driver approval may be required for all users joining a ride (who have been invited by other users/participants). Ride participation rules may further include passenger-initiated invitations (wherein connected passengers can invite their connections, but drivers maintain final approval authority) and group-based discovery (wherein users can discover potential connections through groups and minimal information is visible prior to the establishment of a connection). In an embodiment, connection verification service 514 is configured to enforce connection-based ride creation rules, ensuring that ride coordination is enabled only when a valid carpooling connection exists between the driver and each participant.

According to an embodiment, the multi-layer verification system is configured for geographic redundancy, load distribution, security protocol synchronization, and real-time threat response. Connection management of the present invention enables user-initiated connections with direct and indirect connection paths and implements a mutual approval system. Furthermore, group-based discovery implements background safety verification for added security.

According to an embodiment, system 100 implements a hybrid matching algorithm which combines location-based and interest-based criteria when matching users for a carpool. The hybrid matching algorithm further implements dynamic weighting based on context, supports both immediate and future matching, and optimizes for group efficiency.

Traditional ride-sharing and carpooling platforms expose excessive user data and lack granular privacy controls, creating security vulnerabilities. According to an embodiment, privacy control layer 122 and privacy control module 522 address privacy and data protection concerns by utilizing a privacy-preserving architecture. The privacy-preserving architecture is configured to minimize public data exposure through encrypted user profiles, implement role-based access control for user information, enforce context-aware data sharing boundaries, and provide real-time privacy setting enforcement. Implementing such granular access controls thus decreases privacy violations. Implementation of role-based access control comprises dynamic permission calculation, real-time role updates, hierarchical role inheritance, and context-aware permission evaluation.

According to an embodiment, the privacy-preserving architecture is configured to implement role-based access control, dynamic permission management, secure data handling, and administrative audit logging. The privacy control system of the present invention further implements context-aware information sharing, temporary access mechanisms, group-specific visibility rules, and encrypted data transmission. Information visibility handler 128 implements data visibility rules, wherein only a name and icon are visible at the public level, shared ride history is visible at a connected level, membership-based access is granted at a group level, and system-level access is granted at an administrative level.

According to an embodiment, information visibility handler 128 ensures that only users' names and icons are publicly available, wherein additional user-specified details may be shared in order to request a connection and also following the establishment of a connection. Information visibility handler 128 further enables connection-based information access, temporary ride-specific permissions, and group membership visibility rules.

Existing ride-sharing and carpooling platforms lack mechanisms for building trusted carpooling communities, leading to reduced participation and security concerns. According to an embodiment, system 100 addresses group formation and trust concerns by implementing a scalable group management system (group management components 800). The scalable group management system is configured to dynamically form location-based groups using geofencing, validate group membership through cryptographic proofs, maintain minimal public exposure while enabling discovery, and support verified interest-based affiliations. This enables trusted community formation while maintaining security.

According to an embodiment, the scalable group management system implements dynamic boundary adjustment, automated membership management, cross-group coordination, and event-based group creation. There is a growing emphasis on trust and safety and an increased demand for group-specific solutions amongst carpooling users. The scalable group management system of the present invention addresses these demands—it is configured to coordinate multiple riders for specific events, plan future rides based on shared interests, match users for group activities, and integrate with event scheduling. System 100 is further configured to create temporary event-based groups while also managing recurring ride arrangements.

Existing ride-sharing and carpooling systems react to security incidents after they occur, failing to prevent unauthorized access and fraudulent activity. In contrast, according to an embodiment, system 100 implements real-time security monitoring via security monitoring service 136. Security monitoring service 136 implements a proactive security framework configured to monitor connection patterns in real-time, detect anomalous behavior through pattern analysis, enforce security policies through distributed validation, and enable immediate threat response through automated controls. As such, security monitoring service 136 prevents security incidents through real-time monitoring and response.

According to an embodiment, security monitoring service 136 is configured for administrative pattern recognition, background behavioral analysis, silent incident classification, automated threat classification, and automated response protocols. Security monitoring service 136 implements real-time analysis with machine learning for anomaly detection using a combination of clustering and classification algorithms, such as k-means and support vector machines, to identify unusual user behavior and potential security threats. Security monitoring service 136 engages in real-time behavioral analysis wherein machine learning models analyze user activity patterns, such as login frequency, location changes, and connection requests, to detect suspicious behavior and potential security threats. Security monitoring service 136 utilizes statistical pattern matching wherein algorithms such as Bayesian networks and Hidden Markov Models are used to identify recurring patterns and anomalies in user behavior and connection graphs.

When security monitoring service 136 identifies an incident, incident response handler 140 is configured to handle the incident by implementing one or more of immediate account suspension capabilities, forensic data collection, and automated response triggers. Incident response handler 140 is further configured to engage in connection graph analysis using graph traversal algorithms, such as breadth-first search and depth-first search, to identify patterns and anomalies in user connections.

According to an embodiment, security monitoring service 136 is configured to track certain automated monitoring flags, such as unusual activity patterns, rapid connection changes, multiple incident reports, and geographic anomalies. The presence of any one of these flags triggers an administrative response by incident response handler 140. The response may be determined based on the classification of the security incident as a level 1 through level 4 incident. A level 1 incident triggers a response of enhanced monitoring of the user(s) associated with the incident, a level 2 incident triggers administrative review of the associated user(s), a level 3 triggers temporary restrictions of the associated user(s), and a level 4 triggers account suspension of the associated user(s).

According to an embodiment, real-time triggers of system 100 response actions include detection of pattern deviation, activation of security protocol, administrative alerts, and automated safeguards. System 100 implements scheduled assessments such as pattern analysis review, security audit logging, and threat pattern updates. System 100 is further configured for security threshold management, incident response protocols, pattern recognition updates, and system-wide calibration based on regional security patterns, time-based activity norms, event-specific contexts, and global threat patterns.

In an embodiment, incident response handler 140 comprises an administrative trust validation module configured to identify a security threat using real-time usage analytics and anomaly detection algorithms as described herein. The administrative trust validation module is further configured to mitigate the identified security threat according to a predefined response protocol such as those described above.

According to an embodiment, system 100 is configured for smart vehicle integration (with telematics data utilization, automated vehicle access, real-time capacity monitoring, and fuel consumption tracking) and IoT device coordination (with smart parking integration, traffic signal coordination, environmental monitoring, and occupancy detection). System 100 may further be configured to implement extended reality applications such as augmented reality features (e.g., driver/rider identification, navigation overlay, meeting point visualization, and vehicle recognition), as well as virtual reality implementations (e.g., remote ride planning, group coordination spaces, virtual payment handling, and training simulations).

In an embodiment, system 100 is configured with edge computing architecture for distributed processing, including local trust verification, real-time route optimization, immediate matching decisions, and offline operation capability. Edge computing architecture provides performance benefits such as reduced latency, bandwidth optimization, enhanced privacy, and improved reliability.

In some embodiments, system 100 may be configured for enterprise implementation with corporate-specific features such as department-based groups, cost center billing, corporate policy enforcement, and employee verification integration. System 100 may be configured as an educational institution model with campus-specific adaptations such as student/faculty groups, academic schedule integration, campus boundary geofencing, and university payment systems. System 100 may be configured for event management integration with specialized event features including ticket verification, VIP group management, multi-venue coordination, and schedule synchronization.

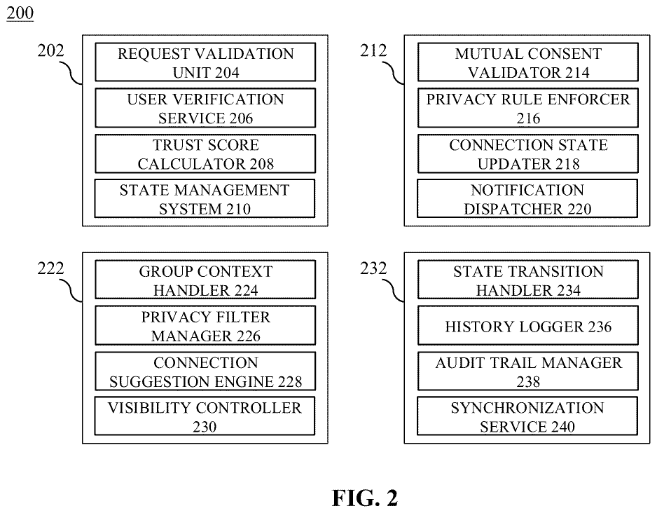

With reference to FIG. 2, request processing components 200 of a connection management process are disclosed. Request processing components 200 comprise connection request handler 202, approval workflow engine 212, discovery integration module 222, and status management system 232. Connection request handler 202 comprises request validation unit 204, user verification service 206, trust score calculator 208, and state management system 210. Approval workflow engine 212 comprises mutual consent validator 214, privacy rule enforcer 216, connection state updater 218, and notification dispatcher 220. Approval workflow engine 110 comprises approval workflow engine 212. Discovery integration module 222 comprises group context handler 224, privacy filter manager 226, connection suggestion engine 228, and visibility controller 230. Status management system 232 comprises state transition handler 234, history logger 236, audit trail manager 238, and synchronization service 240.

According to an embodiment, the present invention comprises a real-time update architecture which utilizes a publish-subscribe messaging system and distributed caching to ensure efficient and consistent state synchronization across nodes. Synchronization service 240 of status manager system 232 comprises a state synchronization engine with the following primary components: a distributed event bus comprising/configured for a message queuing system, priority-based routing, guaranteed delivery protocols, and dead letter handling, and a state reconciliation service comprising/configured for vector clock implementation, conflict resolution rules, eventually consistent model, and state merkle trees.

According to an embodiment, the present invention comprises a conflict resolution framework with detection thresholds (e.g., version vector divergence>suggested 3 updates, timestamp difference>suggested 15 minutes, state hash mismatches, and contradictory group memberships) and resolution hierarchy (e.g., driver updates take precedence, majority consensus for passenger updates, latest verified state for group changes, and administrative override capability).

According to an embodiment, the present invention is configured with fallback procedures such as primary resolution (e.g., automatic state resynchronization, temporary state locking, version vector reconciliation, and delta-based updates) and edge case handling (e.g., disconnected user management, network failure recovery, partial update reconciliation, state reconstruction).

In an embodiment, the present invention is configured for update propagation protocol such as change detection (e.g., local state changes, remote updates, conflict identification (threshold-based), and version vectors) and distribution strategy (e.g., geographic sharding, regional propagation, hierarchical broadcasting, and adaptive batching). Recovery mechanisms may comprise temporary state management (e.g., ride suspension during disconnection, 30-minute timestamp buffer, change log maintenance, and state backtracking capability) and reconnection protocol (e.g., progressive state reconciliation, change verification, update replay, and consistency validation). Administrative controls may comprise manual intervention triggers (e.g., 3 consecutive failed resolutions, 30-minute sustained inconsistency, critical state conflicts, and security threshold violations) and resolution tools (e.g., state forcing capability, update rollback, partial state reset, and user notification system).

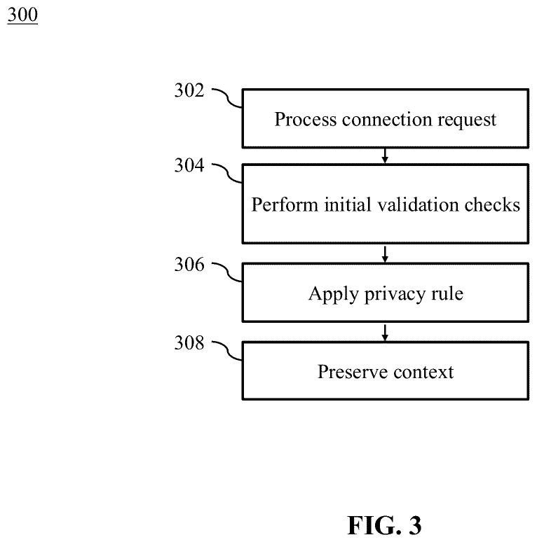

With reference to FIG. 3, a request initiation process 300 using core system components 170 and request processing components 200 to manage a carpooling connection in accordance with some embodiments will now be described. The process of FIG. 3 comprises steps 302 through 308 and is suitable for use in system 100 but is more generally applicable to other types of carpooling systems.

At step 302, connection request handler 202 receives and processes a carpooling connection request. At step 304, request validation unit 204 performs initial validation checks on the connection request. At step 306, privacy rule enforcer 216 applies one or more privacy rules. At step 308, context preservation unit 830 preserves the context.

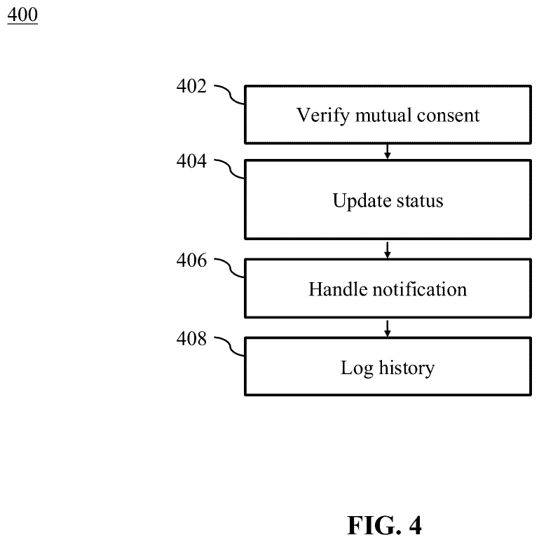

With reference to FIG. 4, an approval process 400 using core system components 170 and request processing components 200 to manage a carpooling connection in accordance with some embodiments will now be described. The process of FIG. 4 comprises steps 402 through 408 and is suitable for use in system 100 but is more generally applicable to other types of carpooling systems.

At step 402, mutual consent validator 204 verifies mutual consent between users to share a ride. At step 404, connection state updater 218 updates the connection status (e.g., “approved” or “not approved”). At step 406, notification dispatcher 220 handles notification of the connection status. At step 408, history logger 236 logs the carpooling connection history.

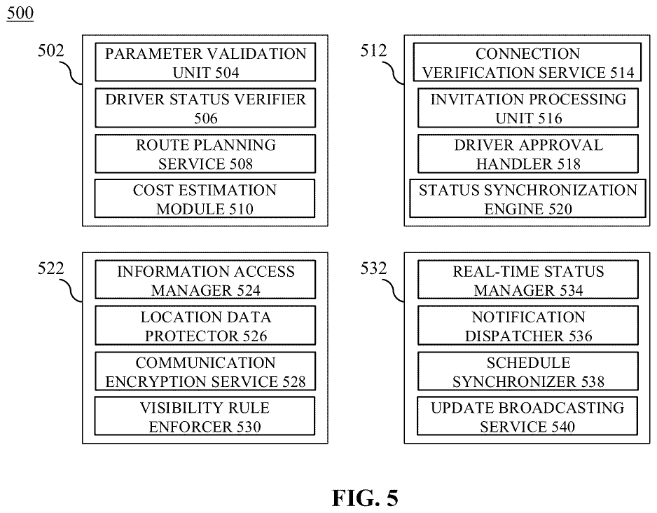

With reference to FIG. 5, ride management components 500 configured for ride creation and participation are disclosed. Ride management components 500 comprise ride creation engine 502, participant management system 512, privacy control module 522, and coordination engine 532. Ride creation engine 502 comprises parameter validation unit 504, driver status verifier 506, route planning service 508, and cost estimation module 510. Participant management system 512 comprises connection verification service 514, invitation processing unit 516, driver approval handler 518, and status synchronization engine 520. Privacy control module 522 comprises information access manager 524, location data protector 526, communication encryption service 528, and visibility rule enforcer 530. Coordination engine 532 comprises real-time status manager 534, notification dispatcher 536, schedule synchronizer 538, and update broadcasting service 540.

Coordination engine 532 is configured to implement connection verification features including direct driver connections, passenger connection validation, invitation permission checking, and driver approval confirmation. Ride creation engine 502 is configured to implement coordination features including connected passenger invitations, driver approval workflow, schedule synchronization, and route optimization. Ride management components 500 are configured to process ride modifications and cancellations, as well as to update pickup arrangements dynamically. Privacy control module 522 is configured to implement privacy management features such as selective information sharing, location data protection, contact detail masking, and temporary access grants.

According to an embodiment, the present invention comprises a secure communication interface which utilizes signal protocol for end-to end encrypted messaging, ensuring secure and private communication between users. For example, message threading is configured for privacy-preserving chat (which utilizes end-to-end encryption indicators, participant status icons, message privacy levels, and ephemeral message controls) and ride coordination (which implements location sharing toggles, ETA updates, route modification requests, and status change notifications).

In an embodiment, the present invention is configured for the following communication alternatives: (1) offline mode operations with limited connectivity features including cached group data, local authentication, delayed synchronization, and emergency protocols; and (2) mesh network support enabling peer-to-peer communication with direct device connections, local group coordination, distributed ride matching, and network-independent operation.

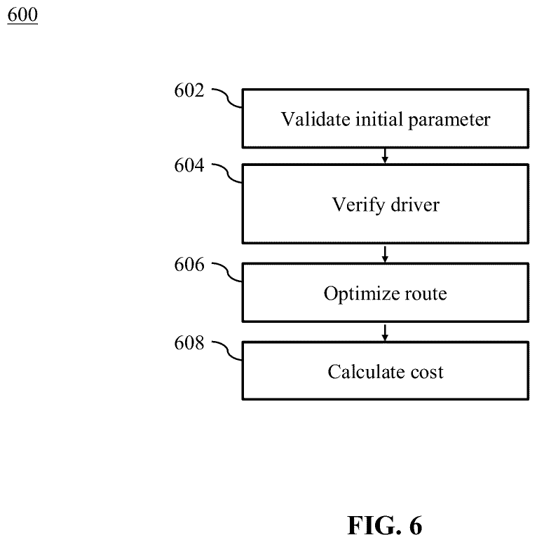

With reference to FIG. 6, a ride creation process 600 using core system components 170 and ride management components 500 (i.e., ride creation engine 502) in accordance with some embodiments will now be described. The process of FIG. 6 comprises steps 602 through 608 and is suitable for use in system 100 but is more generally applicable to other types of carpooling systems.

At step 602, parameter validation unit 504 validates the initial parameters for a ride. At step 604, driver status verifier 506 verifies a driver of the ride. At step 606, route planning service 508 optimizes the route for the ride. At step 608, cost estimation module 510 calculates the cost of the ride, including a cost breakdown for carpooling users.

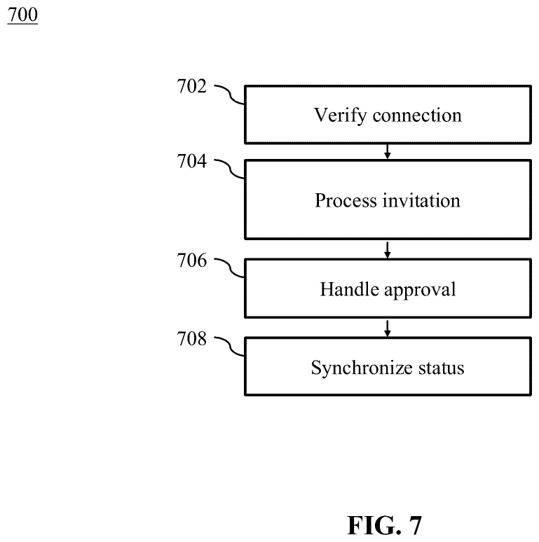

With reference to FIG. 7, a participation management process 700 using core system components 170 and ride management components 500 (i.e., participant management system 512) in accordance with some embodiments will now be described. The process of FIG. 7 comprises steps 702 through 708 and is suitable for use in system 100 but is more generally applicable to other types of carpooling systems.

At step 702, connection verification service 514 verifies a carpooling connection between users for a given ride. At step 704, invitation processing unit 516 processes an invitation from a first user to share a ride with a second user. Driver approval handler 518 may implement a driver approval mechanism wherein the driver of the ride must provide approval to establish the carpooling connection. In an embodiment, the present invention is configured to implement a mutual approval mechanism wherein the first user and the second user must each provide approval to establish the carpooling connection. This may be in addition to or instead of the driver approval mechanism. At step 706, driver approval handler 518 handles the approval of the ride by the driver. At step 708, status synchronization engine 520 synchronizes the status of the carpool.

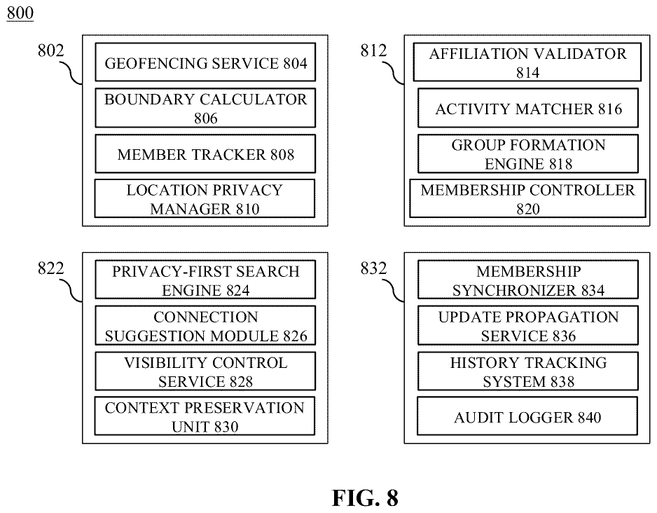

With reference to FIG. 8, group management components 800 configured for group management and discovery are disclosed. Group management components 800 comprise local group engine 802, interest group handler 812, discovery system 822, and group state manager 832. Location group engine 802 comprises geofencing service 804, boundary calculator 806, member tracker 808, and location privacy manager 810. Interest group handler 812 comprises affiliation validator 814, activity matcher 816, group formation engine 818, and membership controller 820. Discovery system 822 comprises privacy-first search engine 824, connection suggestion module 826, visibility control service 828, and context preservation unit 830. Group state manager 832 comprises membership synchronizer 834, update propagation service 836, history tracking system 838, and audit logger 840.

In an embodiment, geofencing service 804 utilizes polygon-based geofencing using the Google Maps™ Platform. The geofencing implementation may comprise dynamic polygon creation based on population density, road networks, natural boundaries, and activity centers. Optimization features may include point-in-polygon algorithms, spatial indexing, boundary simplification, and cache-based lookup. In an embodiment, geofencing service 804 is configured for multi-level geofencing including primary boundaries (city/region level), secondary boundaries (neighborhood level), event-specific boundaries, and dynamic adjustment based on activity patterns.

According to an embodiment, ride management components 500 and group management components 800 are configured to implement a ride matching and coordination process. The ride matching and coordination process comprises trust threshold verification (by threshold validator 1908), geographic boundary check (by boundary calculator 806), schedule alignment (by schedule synchronizer 538), and group permission validation (by affiliation validator 814).

In an embodiment, the present invention is configured for dynamic boundary management (for example, by group management components 800). A geofence update mechanism is configured for real-time boundary calculation (for example, by boundary calculator 806) and update distribution (for example, by update propagation service 836). Real-time boundary calculation includes dynamic vertex adjustment, population density analysis, activity pattern monitoring, and load balancing considerations. Update distribution includes incremental boundary updates, delta compression, partial update merging, and version control.

Group boundary synchronization operates based on boundary change triggers (e.g., member density changes, activity pattern shifts, time-based adjustments, and administrative updates) and update protocol (e.g., atomic boundary updates, member notification system, cache invalidation, and state consistency checks).

System 100 is configured to support community-based, interest-driven connections between users. In an embodiment, system 100 implements a unified group architecture (i.e., group management components 800) that facilitates connection discovery while maintaining user privacy. Types of groups may include user-created groups and location-based groups. User-created groups may be created with descriptive names that naturally indicate their purpose (e.g., “AI Tech Conference” (event-based) or “Major League Baseball Fans” (interest-based)). Discovery interface 1112 provides a single unified interface for group creation and management. Interest group handler 812 automatically optimizes for group type based on usage patterns detected by pattern recognition service 1504. Location-based groups may be formed automatically based on immediate proximity between users. Boundaries may be determined (by boundary calculator 806) based on the walkable distance to potential ride meetup points (e.g., with a typical radius of 5-15 minutes of walking time). Boundaries may also be dynamically adjusted based on venue type (e.g., conference center or stadium).

Discovery system 822 and discovery interface 1112 implement a privacy-preserving member display wherein only users' names and icons are visible (for all group types). No personal details or user history is shown, connection status is indicated if applicable, and group membership count is visible. Group management components 800 implement a unified control system and privacy controls wherein a single set of management tools is used for all group types. Update propagation service 836 provides automatic membership updates based on location. Discovery interface 1112 provides a simple group creation interface with flexible duration settings. Privacy management center 1132 implements consistent privacy rules across all group types. Visibility control system 1140 and visibility control service 828 are configured to implement group-specific visibility settings. Membership validator 1814 is configured for member verification processes. Coordination engine 532 is configured with cross-group coordination capabilities.

According to an embodiment, the present invention is configured for inter-module integration. Core module integration points exist between connection management and group discovery, group discovery and ride coordination, and ride coordination and connection management.

Connection management (e.g., connection management service 102) and group discovery (e.g., group discovery engine 112) are configured to integrate to exchange data such as user connection status for group visibility, group context for connection requests, privacy settings enforcement, and member discovery permissions. Integration protocols for such data exchanges include real-time connection status updates, group membership validation, privacy rule synchronization, and context preservation handlers.

Group discovery (e.g., group discovery engine 112) and ride coordination (e.g., coordination engine 532) are configured to integrate to exchange data such as group membership verification, event-based ride planning, location-based matching data, and temporal coordination info. Integration protocols for such data exchanges include dynamic group boundary updates, real-time availability matching, event schedule synchronization, and location data validation.

Ride coordination (e.g., coordination engine 532) and connection management (e.g., connection management service 102) are configured to integrate to exchange data such as connection verification for ride access, passenger invitation validation, driver approval status, and ride history updates. Integration protocols for such data exchanges include real-time connection checking, multi-party approval workflow, ride access authorization, and history synchronization.

According to an embodiment, cross-module data flows may exist across privacy control layer 122 (horizontal integration) and a security monitoring system implemented by administrative monitor 132 (vertical integration). Privacy control layer 122 enforces the following across all modules: user visibility rules, data access permissions, information sharing limits, and privacy setting propagation. Integration points include connection visibility control, group information filtering, ride data access management, and profile information display. The security monitoring system monitors the following across all modules: usage patterns, security metrics, performance data, and compliance verification. Integration points include connection pattern analysis, group behavior monitoring, ride coordination validation, and system integrity checks.

Cross-module data flows may further include error propagation and rollback procedures. In the event of a cross-module error—such as a failure in connection status updates, group membership mismatches, or discrepancies in ride coordination data—system 100 will initiate a structured error propagation protocol. Each module will be equipped with predefined error codes and recovery triggers that are communicated through a central event bus. When an error is detected, the affected module immediately notifies all connected modules, which then engage an atomic rollback mechanism to revert to the most recent consistent state recorded in versioned transaction logs. If the error persists beyond a predetermined number of retry attempts (e.g., after three consecutive failed reconciliation attempts), an administrative alert is automatically triggered, and system 100 enters a safe fallback mode. This fallback mode temporarily isolates the affected modules from further state changes while maintaining minimal functionality until manual intervention resolves the issue. This detailed error handling and rollback framework ensures that inter-module data integrity is maintained even in the event of unforeseen errors.

According to an embodiment, error handling and recovery may be address by cross-module error propagation and system-wide integrity. Cross-module error propagation handles errors across boundaries including connection failures, group updates, ride coordination, and privacy enforcement. Recovery protocols include atomic transactions, rollback mechanisms, state reconstruction, and consistency verification. System-wide integrity maintains overall consistency by data validation, state verification, transaction logging, and audit trail maintenance. Integration points include cross-module checkpoints, integrity verification, recovery coordination, and system health monitoring.

The present invention is further configured for real-time synchronization via state management protocol and cache coordination. State management protocol ensures consistency across modules including connection states, group memberships, ride statuses, and privacy settings. Synchronization methods for state management include event-driven updates, periodic reconciliation, conflict resolution, and version control. Cache coordination manages distributed caching including a user connection cache, group membership cache, ride status cache, and privacy setting cache. Update protocols for cache coordination include invalidation broadcasting, lazy loading, write-through updates, and cache coherence maintenance.

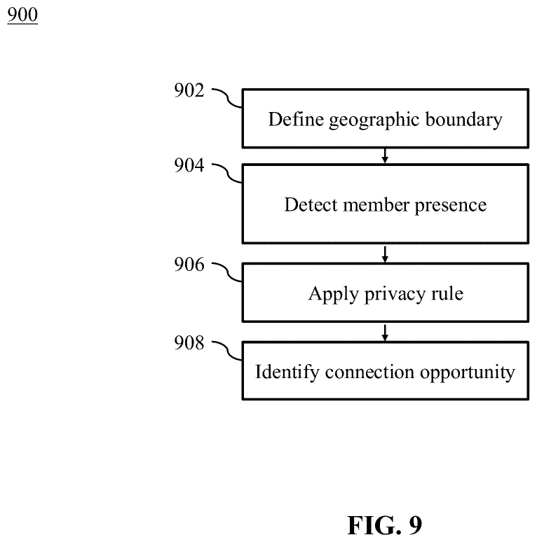

With reference to FIG. 9, a location-based discovery process 900 using core system components 170 and group management components 800 in accordance with some embodiments will now be described. The process of FIG. 9 comprises steps 902 through 908 and is suitable for use in system 100 but is more generally applicable to other types of carpooling systems.

At step 902, geofencing service 804 and boundary calculator 806 define a geographic boundary for group discovery and formation between users. At step 904, member tracker 808 detects the presence of users who are members of a given group (e.g., within the defined geographic boundary). At step 906, location privacy manager 810 applies one or more privacy rules. At step 908, connection suggestion module 826 identifies a connection opportunity between the detected users.

In an embodiment, group management components 800 may comprise a group management module configured to create location-based groups using real-time geofencing. The group management module may be further configured to provide access to a given location-based group based on the current location of a user, and to display information regarding the location-based group to the user. The information may comprise, for example, a name of and an icon for the location-based group. The group management module may store the location-based groups in a groups database. Upon receipt of updated geofencing data, the group management module may update membership of the location-based groups based on the updated geofencing data.

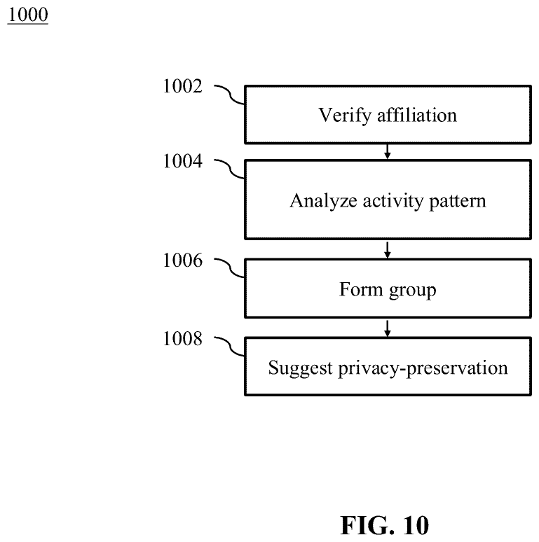

With reference to FIG. 10, an interest-based matching process 1000 using core system components 170 and group management components 800 in accordance with some embodiments will now be described. The process of FIG. 10 comprises steps 1002 through 1008 and is suitable for use in system 100 but is more generally applicable to other types of carpooling systems.

At step 1002, affiliation validator 814 verifies users' affiliations as members of a given interest group. At step 1004, activity matcher 816 analyzes the users' activity pattern(s). At step 1006, group formation engine 818 forms an interest group comprising the users. At step 1008, privacy-first search engine 824 suggests privacy-preservation for the users.

In an embodiment, group management components 800 may comprise a group management module configured to create interest-based groups using real-time user activity data. The group management module may be further configured to provide access to a given interest-based group based on the affiliation(s) of a user, and to display information regarding the interest-based group to the user. The information may comprise, for example, a name of and an icon for the interest-based group. The group management module may store the interest-based groups in a groups database. Upon receipt of updated user activity data, the group management module may update membership of the interest-based groups based on the updated data.

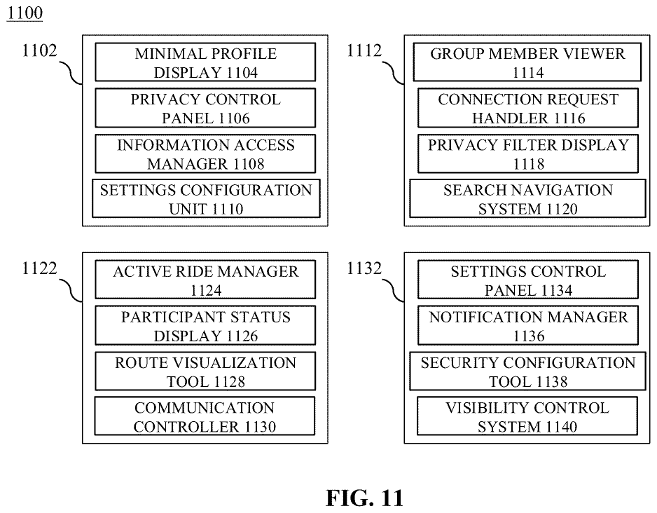

With reference to FIG. 11, interface component architecture 1100 is disclosed. Interface component architecture 1100 comprises profile management interface 1102, discovery interface 1112, ride coordination interface 1122, and privacy management center 1132. Profile management interface 1102 comprises minimal profile display 1104, privacy control panel 1106, information access manager 1108, and settings configuration unit 1110. Discovery interface 1112 comprises group member viewer 1114, connection request handler 1116, privacy filter display 1118, and search navigation system 1120. Ride coordination interface 1122 comprises active ride manager 1124, participant status display 1126, route visualization tool 1128, and communication controller 1130. Privacy management center 1132 comprises settings control panel 1134, notification manager 1136, security configuration tool 1138, and visibility control system 1140.

According to an embodiment, interface component architecture 1100 is configured to implement a privacy-first information display (maintained by privacy management center 1132) and a connection management interface (maintained by discovery interface 1112). Interface component architecture 1100 is further configured to enable group discovery navigation (via discovery interface 1112) and settings configuration (via settings configuration unit 1110 of profile management interface 1102).

Interface component architecture 1100 is configured with a privacy-first user interface (“UI”) implementation that prioritizes user privacy by minimizing data exposure and providing granular control over information sharing. An initial user display implementing progressive information disclosure comprises a pre-connection view (displaying, e.g., name only, generic avatar or icon, group affiliations (count only), and connection status indicator), as well as post-connection stages. Post-connection stages comprise stage 1 (i.e., basic connection) (displaying, e.g., profile photo, verified status badges, shared group names, and common connections) and stage 2 (i.e., ride participant) (displaying, e.g., contact preferences, location sharing (ride-specific), schedule availability, and payment information).

Context-aware interface components comprise a group discovery view, with list view controls (e.g., minimal member previews, group context indicators, activity status dots, and privacy setting icons) and detail view transitions (e.g., gesture-based expansions, progressive loading, permission-based content, and context preservation). Privacy control visualization enables settings management, such as visual privacy levels (e.g., slider-based controls, color-coded indicators, permission matrices, and scope visualizations) and real-time feedback (e.g., preview mode, impact indicators, visibility simulators, and access summaries). A connection-based UI adaptation comprises dynamic interface elements such as connection status changes (e.g., visual state transitions, permission-based UI updates, content availability indicators, and access level badges) and contextual controls (e.g., role-specific actions, permission-based buttons, conditional navigation, and dynamic form fields).

The present invention is configured to balance user control with automated privacy settings by giving users flexibility in managing their privacy settings while ensuring that critical security protocols remain in place. In cases where a user's chosen privacy preference conflicts with system-enforced security requirements-such as when a user attempts to reveal additional personal information that could compromise platform integrity—the system will automatically override the user's input. In such instances, the UI displays an alert explaining that a default, secure setting is being applied for safety reasons. Additionally, a log of these overrides is maintained for review, and users can access further details through the privacy control panel. This approach ensures that while users maintain as much control as possible, the overall security and integrity of the platform are never compromised.

The present invention is configured for error handling and feedback, including comprehensive error logging, user-friendly error messages, and automated recovery mechanisms to ensure a smooth user experience. User notifications comprise privacy-aware alerts (e.g., permission requirement notices, connection status updates. access denial explanations, and security alert indicators) and progressive resolution (e.g., step-by-step guidance, permission request flows, verification processes, and recovery options). Furthermore, accessibility considerations are addressed through features such as screen reader compatibility, keyboard navigation, and alternative input methods, making the platform accessible to users with disabilities. Privacy-preserving accessibility features of the present invention comprise screen reader support (e.g., context-preserving descriptions, privacy-aware announcements, secure state changes, and permission-based content) and input adaptations (e.g., alternative authentication, simplified permissions, enhanced visibility options, and adaptive interfaces).

Ride coordination interface 1122 is configured to process ride requests based on direct connections with the driver, connected passenger invitations, driver approval status, and schedule compatibility.

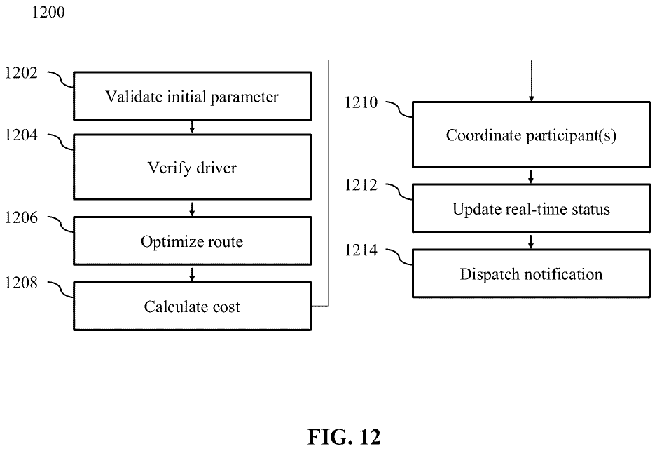

With reference to FIG. 12, a ride management process 1200 using core system components 170 and user interface component architecture 1100 in accordance with some embodiments will now be described. The process of FIG. 12 comprises steps 1202 through 1214 and is suitable for use in system 100 but is more generally applicable to other types of carpooling systems.

At step 1202, parameter validation unit 504 validates the initial parameters for a ride. At step 1204, driver status verifier 506 verifies a driver of the ride. At step 1206, route planning service 508 optimizes the route for the ride. At step 1208, cost estimation module 510 calculates the cost of the ride, including a cost breakdown for carpooling users.

At step 1210, participant management system 512 coordinates one or more participants/users for the ride. At step 1212, real-time status manager 534 updates the real-time status of the ride. At step 1214, notification dispatcher 536 dispatches ride notifications as secure messages to the one or more users in the ride.

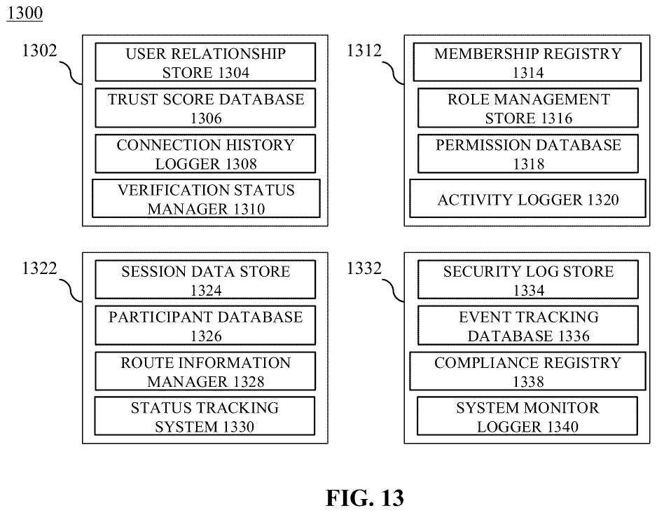

With reference to FIG. 13, data structure components of a database schema 1300 are disclosed. According to an embodiment, database schema 1300 comprises connection management schema 1302, group data schema 1312, ride coordination schema 1322, and audit trail schema 1332. Connection management schema 1302 comprises user relationship store 1304, trust score database 1306, connection history logger 1308, and verification status manager 1310. Group data schema 1312 comprises membership registry 1314, role management store 1316, permission database 1318, and activity logger 1320. Ride coordination schema 1322 comprises session data store 1324, participant database 1326, route information manager 1328, and status tracking system 1330. Audit trail schema 1332 comprises security log store 1334, event tracking database 1336, compliance registry 1338, and system monitor logger 1340.

According to an embodiment, user profiles, groups, and rides are stored in relational databases with a schema designed to optimize query performance and data integrity. A user profile schema is configured to store basic identification information for each user, verified connections, group memberships, and trust metrics. A group schema is configured to store membership rules, geographic boundaries, privacy settings, and event associations. A ride schema is configured to store route information, participant data, payment details, and status tracking.

According to an embodiment, database schema 1300 is configured for core data management including user relationship tracking (by user relationship store 1304), group membership handling (by membership registry 1314), ride coordination storage (by ride coordination schema 1322), and security audit logging (by audit trail schema 1332).

Database schema 1300 stores user profiles (with minimal public data), connection relationships (in connection management schema 1302), group memberships (in group data schema 1312), and ride coordination records (in ride coordination schema 1322). Database schema 1300 comprises a security implementation with encrypted data storage, access control lists, audit logging, and data retention policies. System health monitor 1522 implements performance optimization tools including connection graph indexing, geospatial query optimization, cache management, and query performance tuning.

According to an embodiment, database schema 1300 comprises a primary data store (e.g., Cloud Spanner™) for transactional data. The primary data store is configured for regional deployment, multi-region failover, automatic sharding, and real-time replication. Secondary storage may include MongoDB™ for user profiles and preferences, Redis™ for session management, Elasticsearch™ for search operations, and Google Cloud Storage™ for media files.

In an embodiment, database schema 1300 comprises document-based storage (NoSQL implementation) for user profiles, group configurations, ride histories, and event data. Document-based storage provides flexible schema evolution, improved scalability, better handling of unstructured data, and enhanced query performance for complex relationships. In another embodiment, database schema 1300 comprises a relational database structure (SQL implementation) for user relationships, transaction records, authentication data, and group memberships. A relational database structure offers ACID compliance, complex join operations, structured data integrity, and traditional reporting capabilities. In another embodiment, database schema 1300 comprises a hybrid database approach wherein a combined implementation uses NoSQL for real-time features, SQL for financial transactions, specialized databases for geospatial data, and cache layers for performance optimization.

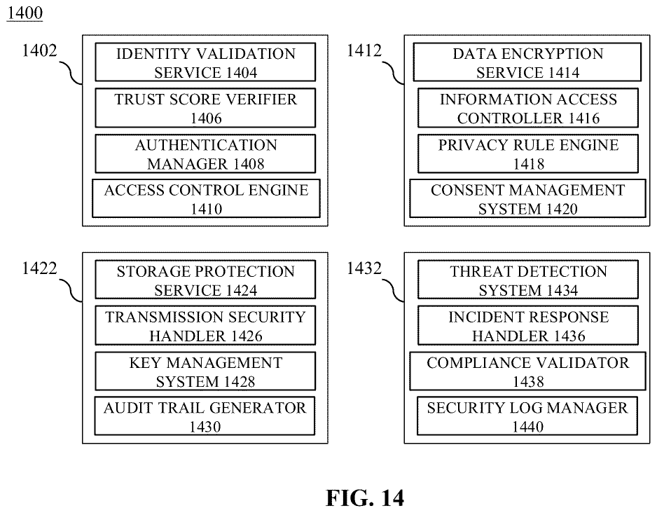

With reference to FIG. 14, security architecture components of security implementation 1400 are disclosed. Security implementation 1400 comprises connection verification layer 1402, privacy protection system 1412, data security module 1422, and security monitoring engine 1432. Connection verification layer 1402 comprises identity validation service 1404, trust score verifier 1406, authentication manager 1408, and access control engine 1410. Privacy protection system 1412 comprises data encryption service 1414, information access controller 1416, privacy rule engine 1418, and consent management system 1420. Data security module 1422 comprises storage protection service 1424, transmission security handler 1426, key management system 1428, and audit trail generator 1430. Security monitoring engine 1432 comprises threat detection system 1434, incident response handler 1436, compliance validator 1438, and security log manager 1440. Incident response handler 1436 is similar in configuration and function to incident response handler 140.

According to an embodiment, security implementation 1400 is configured to implement a user authentication and connection management process. The user authentication and connection management process comprises initial identity verification (by identity validation service 1404), social connection validation (by direct connection validator 1804), group membership confirmation (by membership validator 1814), and trust score calculation (by trust score calculator 208). The user authentication and connection management process incorporates privacy controls and administrative monitoring to ensure secure and trusted operations.

According to an embodiment, system 100 is configured to implement a user interaction process comprising user authentication and authorization (by security implementation 1400), connection management (by connection state manager 106), group participation (by membership validator 1814), and privacy enforcement (by privacy rule enforcer 216). Authentication by security implementation 1400 comprises multi-factor verification, trust score validation (by trust score verifier 1406), access permissions management (by access control engine 1410), and session security maintenance. Security implementation 1400 is further configured for data protection by encryption implementation (by data encryption service 1414), privacy rule enforcement (by privacy rule engine 1418), secure data transmission (by transmission security handler 1426), and access control validation (by access control engine 1410).

In an embodiment, security implementation 1400 may comprise a secure processing engine configured to authenticate and validate connection-based ride operations, implement real-time group discovery algorithms, enforce hierarchical privacy rules across system operations, coordinate concurrent ride sessions with encrypted communication, and maintain distributed system state consistency.

In an embodiment, security implementation 1400 is configured for data protection (with end-to-end encryption using AES-256, perfect forward secrecy, zero-knowledge proof for sensitive data, and secure key management using Cloud KMS) and access control (with role-based access control (RBAC), OAuth 2.0 with OpenID Connect, JWT for API authentication, and rate limiting and request throttling).

The following comprises a cryptographic implementation diagram supporting FIG. 14:

### Key Rotation Protocol:

1. Master Key (HSM-protected) generates monthly Data Encryption Keys
2. DEKs encrypted with RSA-4096 public keys
3. Key versioning maintained in distributed ledger
4. Automatic revocation via CRL/OCSP

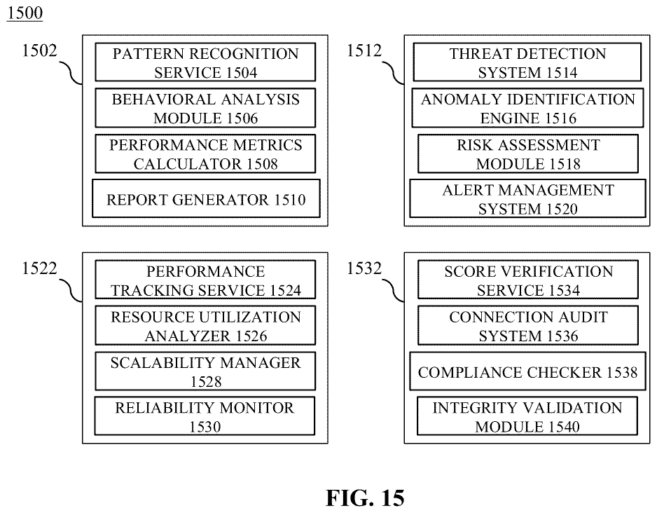

With reference to FIG. 15, components of administrative monitoring system 1500 are disclosed. Administrative monitoring system 1500 comprises usage analytics engine 1502, security monitoring service 1512, system health monitor 1522, and trust validation engine 1532. Usage analytics engine 1502 comprises pattern recognition service 1504, behavioral analysis module 1506, performance metrics calculator 1508, and report generator 1510. Security monitoring service 136 comprises security monitoring service 1512. Security monitoring service 1512 comprises threat detection system 1514, anomaly identification engine 1516, risk assessment module 1518, and alert management system 1520. System health monitor 1522 comprises performance tracking service 1524, resource utilization analyzer 1526, scalability manager 1528, and reliability monitor 1530. Trust validation engine 1532 comprises score verification service 1534, connection audit system 1536, compliance checker 1538, and integrity validation module 1540.

According to an embodiment, administrative monitoring system 1500 is configured to implement an analytics process. The analytics process comprises data collection and aggregation, pattern analysis and detection (by pattern recognition service 1504), performance measurement (by performance metrics calculator 1508), and report generation (by report generator 1510). Administrative monitoring system 1500 is further configured to implement a security management process comprising real-time threat monitoring (by threat detection system 1514), incident response coordination (by incident response handler 1436), risk assessment (by risk assessment module 1518), and compliance verification (by compliance checker 1538). Administrative monitoring system 1500 is further configured for system state management including real-time updates, historical tracking (by history tracking system 838), performance monitoring (by performance metrics calculator 1508 and performance tracking service 1524), and compliance verification (by compliance checker 1538). In an embodiment, administrative monitoring system 1500 is configured to utilize machine learning-based anomaly detection algorithms to identify and respond to potential security threats in real time.

In an embodiment, administrative monitoring system 1500 is further configured for performance optimization using an update batching system and cache management. The update batching system may be based on batch formation rules (e.g., priority-based batching, size optimization, latency requirements, and resource constraints) and distribution strategy (e.g., geographic routing, load balancing, network condition adaptation, and failure recovery). Cache management may include a cache hierarchy (e.g., local device cache, edge cache layers, regional cache nodes, and global cache coordination) and invalidation protocol (e.g., selective invalidation, lazy update propagation, cache coherence maintenance, and stale data prevention).

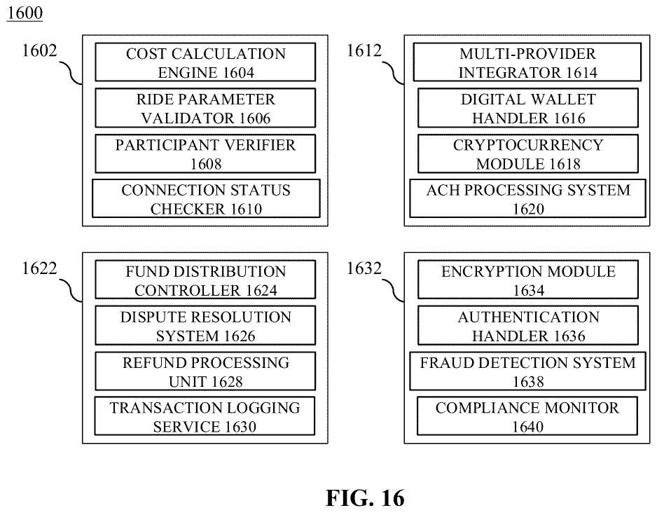

With reference to FIG. 16, payment flow components of a payment processing architecture 1600 are disclosed. Payment processing architecture 1600 comprises transaction initiation system 1602, payment processing engine 1612, settlement manager 1622, and security layer 1632. Transaction initiation system 1602 comprises cost calculation engine 1604, ride parameter validator 1606, participant verifier 1608, and connection status checker 1610. Payment processing engine 1612 comprises multi-provider integrator 1614, digital wallet handler 1616, cryptocurrency module 1618, and ACH processing system 1620. Settlement manager 1622 comprises fund distribution controller 1624, dispute resolution system 1626, refund processing unit 1628, and transaction logging service 1630. Security layer 1632 comprises encryption module 1634, authentication handler 1636, fraud detection system 1638, and compliance monitor 1640.

According to an embodiment, payment processing architecture 1600 is configured to implement a payment process. The payment process comprises cost calculation (by cost calculation engine 1604), participant verification (by participant verifier 1608), payment authorization (by payment processing engine 1612), and settlement execution (by settlement manager 1622). The cost calculation process implemented by cost calculation engine 1604 comprises ride parameter analysis (by ride parameter validator 1606), distance/time calculations, group split computations, and fee structure application.

Payment processing architecture 1600 is further configured to implement a security protocol process. The security protocol process comprises identify verification (by identity validation service 1404), encryption implementation (by encryption module 1634), fraud detection (by fraud detection system 1638), and compliance checking (by compliance monitor 1640).

In an embodiment, the payment processing architecture implements Stripe Connect as a primary payment system for marketplace payments. The primary payment system offers multi-currency support, automated fee calculation, instant payout capability. Alternative payment methods may include digital wallet integration, ACH transfers, international payment support, and cryptocurrency capability.

According to an embodiment, the present invention is configured for connection status management including real-time status updates utilizing status change processing (e.g., change validation, priority determination, impact assessment, and cascade evaluation) and distribution management (e.g., affected user identification, update ordering, delivery confirmation, and fallback mechanisms). The present invention is further configured for consistency maintenance using version control (e.g., status version vectors, change history logs, rollback capabilities, and forward recovery) and conflict resolution (e.g., last-writer-wins rules, multi-master resolution, user preference preservation, and state reconstruction).

The following comprises a distributed ledger conflict resolution flow supporting FIG. 16:

### Conflict Handling Process:

1. Detect version vector divergence>3 updates
2. Initiate Byzantine Fault Tolerance consensus
3. Validate timestamps against NTP-synced nodes
4. Apply deterministic merge rules:
Driver state overrides passengers
Majority consensus for group memberships
Latest verified geofence coordinates

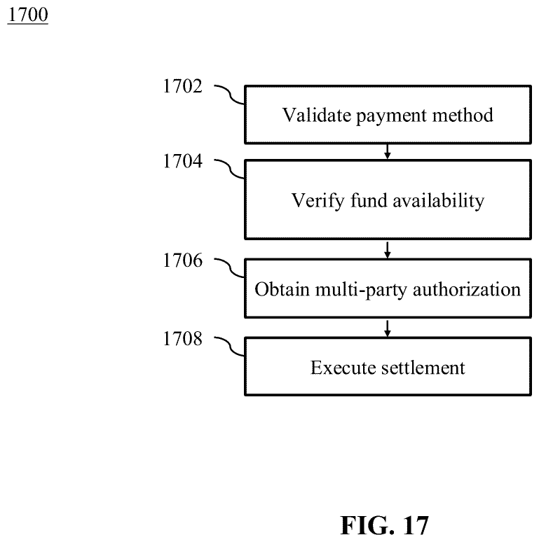

With reference to FIG. 17, a payment processing transaction process 1700 using core system components 170 and payment processing architecture 1600 in accordance with some embodiments will now be described. The process of FIG. 17 comprises steps 1702 through 1708 and is suitable for use in system 100 but is more generally applicable to other types of carpooling systems.

At step 1702, payment processing engine 1612 validates the payment method(s) for one or more users sharing the costs of the ride. For example, users share the cost of gasoline, parking, tolls, insurance, and wear-and-tear. At step 1704, fund distribution controller 1624 verifies fund availability for payment of the costs. At step 1706, multi-provider integrator 1614 obtains multi-party authorization for, for example, payment by each of the users in a carpool. At step 1708, settlement manager 1622 executes settlement of the costs for the ride.

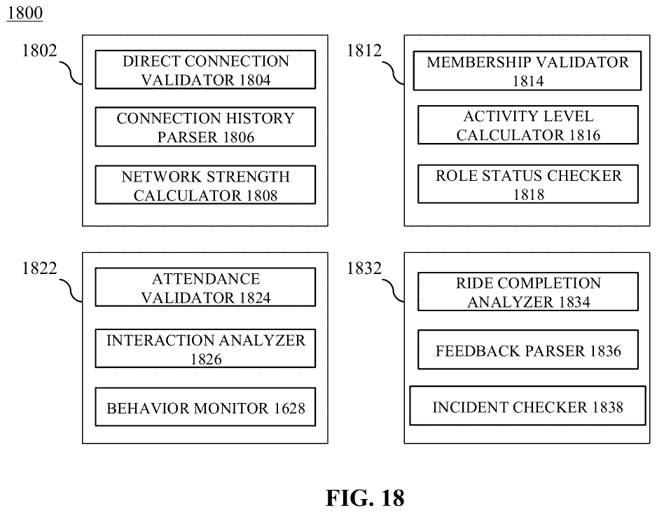

With reference to FIG. 18, input processing components 1800 of a trust score calculation framework are disclosed. According to an embodiment, the trust score calculation framework comprises features including dynamic weight adjustment, real-time score updates, fraud detection integration, audit trail maintenance. The input processing components perform background validation steps for trust score calculation. The output of the trust score calculation comprises an internal security risk assessment, which, according to an embodiment, is for administrative use only. The trust score may range from 0 (indicative of a high or major security risk) to 100 (indicative of a low or non-existent security risk). The input processing components 1800 comprise social connection analyzer 1802, group affiliation processor 1812, event participation engine 1822, and historical data processor 1832.

Social connection analyzer 1802 is configured for automated pattern verification. Social connection analyzer 1802 comprises direct connection validator 1804, connection history parser 1806, and network strength calculator 1808. Social connection analyzer 1802 is configured to perform a connection pattern analysis according to the formula (CPA)=(DC×0.6+AB×0.4)×40, wherein DC=Connection creation/deletion frequency and AB=Abnormal behavior patterns.

Group affiliation processor 1812 is configured for group interaction analysis. Group affiliation processor 1812 comprises membership validator 1814, activity level calculator 1816, and role status checker 1818. Group affiliation processor 1812 is configured to perform a group interaction analysis according to the formula (GIA)=(GM×0.5+GV×0.3+GA×0.2)×30, wherein GM=Group membership volatility, GV=Group violation reports, and GA=Anomalous group activities.

Event participation engine 1822 is configured for event behavior monitoring. Event participation engine 1822 comprises attendance validator 1824, interaction analyzer 1826, and behavior monitor 1628. Event participation engine 1822 is configured to perform event behavior monitoring according to the formula (EBM)=(EP×0.4+EI×0.4+EC×0.2)×20, wherein EP=Event participation patterns, EI=Incident reports, and EC=Compliance violations.

Historical data processor 1832 is configured for security risk calculation. Historical data processor 1832 comprises ride completion analyzer 1834, feedback parser 1836, and incident checker 1838. Historical data processor 1832 is configured to perform historical security analysis according to the formula (HSA)=(VI×0.5+SC×0.3+PR×0.2)×10, wherein VI=Verification irregularities, SC=Security concern reports, and PR=Pattern recognition flags.

The following comprises trust scoring algorithm pseudocode supporting FIG. 18: function calculateTrustScore(user):

#Connection Pattern Analysis (40% weight) cpa=(connection_freq*0.6+anomaly_score*0.4)*40

#Group Interaction Analysis (30% weight)

gia=(membership_volatility*0.5+violation_reports*0.3+anomalous_activities*0.2)*30

#Event Behavior Monitoring (20% weight)

ebm=(event_participation*0.4+incident_count*0.4+compliance_violations*0.2)*20

#Historical Security Analysis (10% weight)

hsa=(verification_issues*0.5+security_reports*0.3+pattern_flags*0.2)*10

raw_score=cpa+gia+ebm+hsa

return min (100, max (0, raw_score))

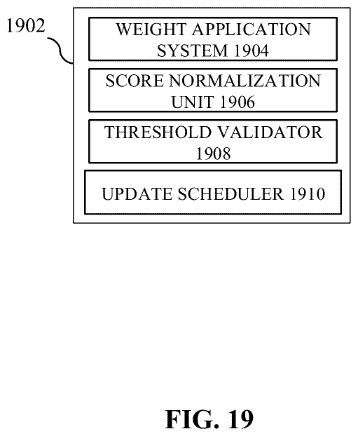

With reference to FIG. 19, calculation engine 1902 of the trust score calculation framework is disclosed. Calculation engine 1902 comprises weight application system 1904, score normalization unit 1906, threshold validator 1908, and update scheduler 1910. Calculation engine 1902 implements a trust validation algorithm—an administrative security tool configured to operate invisibly to users. Administrative input parameters comprise system-detected connection patterns, group behavior monitoring, event participation analysis, and historical security data.

According to an embodiment, a trust score is calculated based on established carpooling connections between users which are stored in a connections database. The trust score may be calculated based on a weighted combination of trust factors such as connection frequency analysis, group membership volatility, event participation patterns, and historical verification irregularities. Each of the trust factors may be assigned a relative weight value.

According to some embodiments, connection pattern metrics may be used as inputs to the trust score calculation framework and are continuously updated based on user activity. Connection Frequency (CF) may refer to the number of new connections created or deleted by a user within a rolling 30-day period, normalized against the platform average. Connection Frequency is calculated according to the equation: CF=(user_connections_30d/platform_avg_30d)*100. Abnormal Behavior Score (AB) may refer to the composite score (0-100) calculated from deviations in: Connection acceptance rate; Geographic distribution of connections; Time-of-day connection patterns; and Connection reciprocation rate.

According to some embodiments, group interaction metrics may be used as inputs to the trust score calculation framework and are continuously updated based on user activity. Membership Volatility (MV) may refer to the rate of group joining/leaving within a 90-day period. Membership Volatility is calculated according to the equation: MV=(groups_joined+groups_left)/max_allowed_groups*100. Group Violation Rate (GV) may refer to the weighted sum of reported violations, wherein GV=Σ(violation_severity_weight*violation_count)/time_period. Group Activity Anomaly (GA) may refer to the statistical deviation from expected group participation patterns, wherein GA=|actual_participation−expected_participation|/standard_deviation.

According to some embodiments, event behavior metrics may be used as inputs to the trust score calculation framework and are continuously updated based on user activity. Event Participation (EP) may refer to the ratio of successful event completions, wherein EP=completed_events/total_events*100. Incident Rate (IR) may refer to the weighted frequency of reported incidents, wherein IR=Σ(incident_severity*incident_count)/total_events. Compliance Score (CS) may refer to the percentage adherence to platform rules, wherein CS=(1−(rule_violations/total_actions))*100.

According to some embodiments, historical security measures may be used as inputs to the trust score calculation framework and are continuously updated based on user activity. Verification Index (VI) may refer to the success rate of identity verification attempts, wherein VI=successful_verifications/total_verification_attempts*100. Security Concern Rate (SC) may refer to the frequency of triggered security alerts, wherein SC=security_alerts/total_platform_interactions*100. Pattern Recognition Flag (PR) may refer to binary flags for recognized security patterns, wherein PR=Σ(pattern_weight*pattern_match_boolean).

These terms as used in the description of specific embodiments generally refer to the above definitions, with variations on that as would be understood by those of skill in the art.

In an embodiment, in addition to calculating trust scores for users as passengers, calculation engine 1902 calculates trust scores for users as drivers as well. For example, if a user is designated as a driver, system 100 is configured to evaluate said user's driving-specific behavior. The driver trust score may be calculated using the same, similar, or distinct datapoints, trust factors, and weighted formulas used for passenger trust score calculations. According to an embodiment, a carpooling connection is only established between one or more passengers and a driver once the driver's trust score is validated against a minimum threshold. System 100 may restrict someone from being a driver but may nevertheless allow them to join carpools as a passenger.

According to an embodiment, calculation engine 1902 is configured to evaluate all users—drivers and passengers alike—for safety. System 100 is configured to address the key concern of whether it is safe to be in a car with a given user. The evaluation embodied by the trust score calculation is based on the user's behavior and activity. System 100 is configured to implement further safety features wherein a user may only join a ride if they have an established carpool connection with another user in the ride. A user may also need the driver's approval before joining a carpool if the user is not already directly connected with the driver.

In an embodiment, if a user's trust score falls below a predetermined minimum threshold, the user may lose access to certain features such as the ability to connect with other users, or the ability to form or join carpools with other users. In an embodiment, if a user's trust score falls below an even lower minimum threshold, the user may be placed into a “sandbox,” wherein the user still retains access to system 100 but is unable to connect with or join carpools with any other users. A sandboxed user is essentially invisible to all other users of system 100.

When calculating a trust score, the connection patterns determined by social connection analyzer 1802, may be assigned, for example, a weight of 0.4. Group behavior monitoring data, determined by group affiliation processor 1812, may be assigned an example weight of 0.3. Event participation analysis data, determined by event participation engine 1822, may be assigned an example weight of 0.2. Historical security data, determined by historical data processor 1832, may be assigned an example weight of 0.1.

Calculation engine 1902 calculates the trust score, or security risk assessment, by calculating a Raw Risk Score according to the formula CPA+GIA+EBM+HSA. Score normalization unit 1906 then calculates a Normalized Risk Level based on the formula min (100, max (0, Raw Risk Score)).

According to an embodiment, calculation engine 1902 utilizes a weighted scoring algorithm (applied by weight application system 1904) based on factors such as connection history, group participation, and security risk assessment, providing an internal metric for administrative monitoring and threat detection. The security monitoring framework described herein, embodied by security monitoring service 136 and 1512 and security monitoring engine 1432, operates as a backend administrative tool. The trust score is used to identify potentially problematic behavior and proactively trigger intervention measures. While it is not displayed to users, the trust score serves as an internal metric to assess the risk level of users and may indirectly influence ride eligibility decisions in certain cases, such as when a user's trust score falls below a critical threshold (as determined by threshold validator 1908). This approach balances user privacy with platform security by allowing for intervention in high-risk situations while maintaining a transparent and connection-based carpooling experience.

According to an embodiment, the trust score calculation framework is configured to operate as a backend security tool for identifying potential platform abuse, detecting suspicious behavior patterns, supporting administrative intervention, maintaining platform integrity, and protecting the user community. Key characteristics of the trust score calculation framework include that it is completely invisible to users (with no public scoring or ranking), used solely for security purposes, supports natural connection building, and prevents competitive behavior.

The matching algorithm architecture of the present invention combines collaborative filtering and content-based filtering techniques to recommend potential ride matches based on user preferences, shared interests, and trust scores. Primary matching criteria include a social trust score threshold (for example, a minimum score of 70), geographic proximity (for example, within a pre-defined geofence), and temporal alignment (for example, a ±25 minute window). Secondary weighting factors include common group memberships, shared event participation, historical ride patterns, and user preferences.

In an embodiment, system 100 utilizes an AI-enhanced matching system comprising machine learning components such as predictive matching algorithms, behavioral pattern analysis, dynamic trust scoring, and route optimization. The AI-enhanced matching system includes features such as user preference learning, fraud detection, dynamic pricing optimization, and automated group suggestions. Implementation methods include neural network-based matching, natural language processing for user communication, computer vision for identity verification, and reinforcement learning for route optimization.

In an embodiment, system 100 implements a decentralized trust framework with blockchain-based implementation, including distributed trust verification, smart contracts for ride agreements, tokenized reputation system, and immutable ride history. A decentralized trust framework provides benefits such as trustless verification, reduced central authority dependence, cross-platform compatibility, and enhanced security through distribution.

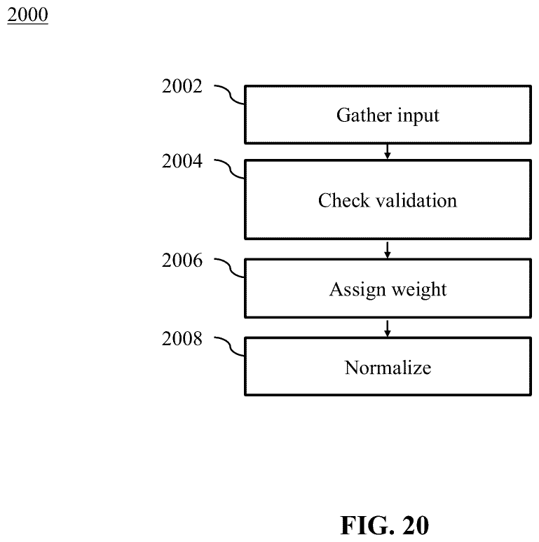

With reference to FIG. 20, a data collection computational process 1700 using core system components 170, input processing components 1800, and calculation engine 1902 in accordance with some embodiments will now be described. The process of FIG. 20 comprises steps 2002 through 2008 and is suitable for use in system 100 but is more generally applicable to other types of carpooling systems.

At step 2002, social connection analyzer 1802, group affiliation processor 1812, event participation engine 1822, and historical data processor 1832 gather input data for use in the calculation of a trust score. At step 2004, direct connection validator 1804, membership validator 1814, and attendance validator 1824 validate their respective data (i.e., direct connections, memberships, and attendance). As described herein with reference to FIG. 19, at step 2006, weight application system 1904 assigns a respective weight to the individual data points for use in the trust score calculation. The connection patterns, determined by social connection analyzer 1802, may be assigned, for example, a weight of 0.4 for the trust score calculation. Group behavior monitoring data, determined by group affiliation processor 1812, may be assigned an example weight of 0.3. Event participation analysis data, determined by event participation engine 1822, may be assigned an example weight of 0.2. Historical security data, determined by historical data processor 1832, may be assigned an example weight of 0.1. At step 2008, score normalization unit 1906 normalizes the trust score calculation output (e.g., by calculating a Normalized Risk Level based on the formula min (100, max (0, Raw Risk Score))).

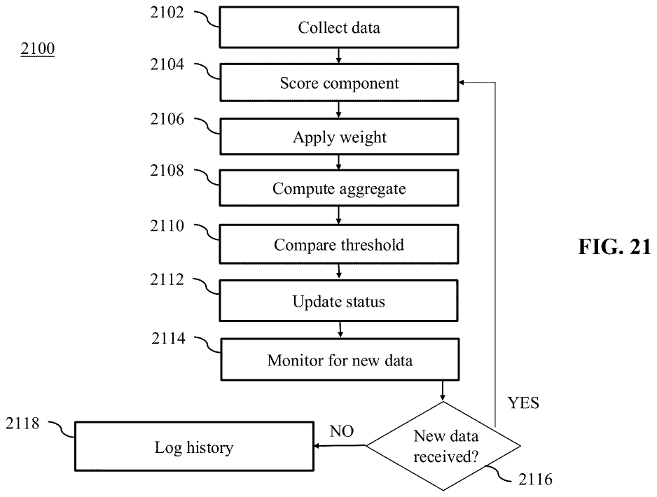

With reference to FIG. 21, a score calculation and update process 2100 using core system components 170, input processing components 1800, and calculation engine 1902 in accordance with some embodiments will now be described. The process of FIG. 21 comprises steps 2102 through 2118 and is suitable for use in system 100 but is more generally applicable to other types of carpooling systems.

At step 2102, social connection analyzer 1802, group affiliation processor 1812, event participation engine 1822, and historical data processor 1832 collect input data for use in the calculation of a trust score for a user. At step 2104, calculation engine 1902 calculates the trust score, or security risk assessment, by calculating a Raw Risk Score according to the formula CPA+GIA+EBM+HSA. As described herein with reference to FIGS. 19 and 20, at step 2106, weight application system 1904 assigns a respective weight to the individual data points for use in the trust score calculation. At step 2108, an aggregate trust score is computed. At step 2110, threshold validator 1908 compares the calculated trust score with a minimum threshold score. At step 2112, update scheduler 1910 defines a schedule for updating the calculated trust score.

At step 2114, social connection analyzer 1802, group affiliation processor 1812, event participation engine 1822, and historical data processor 1832 monitor for new data for use in recalculating the trust score. At step 2116, calculation engine 1902 checks whether new data has been received. If new data has not been received, at step 2118, the history of the trust score calculation, including the trust score itself, is logged in trust score database 1306. If new data has been received, process 2100 proceeds to step 2104, wherein calculation engine 1902 recalculates the trust score, followed by remaining steps 2106-2118.

According to an embodiment, step 2104 is configurable to be automatically triggered based on the storage of new data in any one of trust score database 1306, permission database 1318, participant database 1326, and event tracking database 1336, or based on the receipt of new data by any one of the input processing components 1800. The data may be periodically updated by system 100. The trigger can be set to activate a message or a flag to generate a message based on an elapsed predetermined amount of time or a change to the data. As such, system 100 may utilize up-to-date trust scores when managing carpooling requests. In an embodiment, the data is continuously updated and retrieved from any of the above-mentioned databases. The trust score may be recalculated in response to a change in the updated data or an elapsing of a predetermined amount of time.

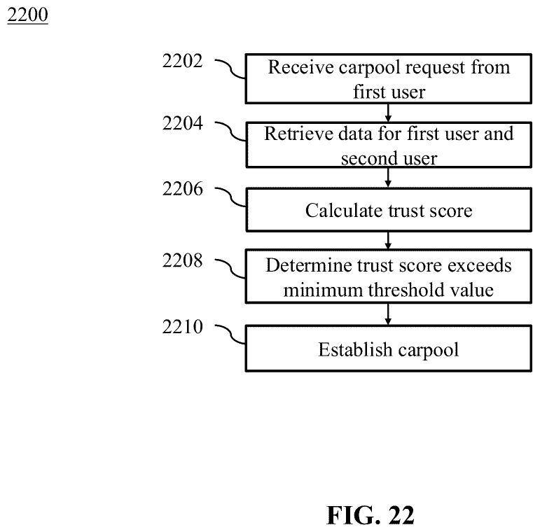

With reference to FIG. 22, a method for secure carpooling 2200 using core system components 170 in accordance with some embodiments will now be described. The process of FIG. 22 comprises steps 2202 through 2210 and is suitable for use in system 100 but is more generally applicable to other types of carpooling systems.

At step 2202, request processing components 200 receive a carpool request from a first user to a second user over a secure communication channel. The first user has an existing carpooling connection with the second user. At step 2204, social connection analyzer 1802, group affiliation processor 1812, event participation engine 1822, and historical data processor 1832 retrieve data for the first user and the second user from a database storing user data. At step 2206, calculation engine 1902 calculates a trust score for the first user and the second user using the retrieved data. As described herein with reference to FIGS. 18-21, the trust score is calculated based on a weighted formula combining one or more trust factors. The trust score is used as an internal administrative tool—it is not public or user-facing.

At step 2208, threshold validator 1908 compares the calculated trust score with a minimum threshold score and determines that the calculated trust score exceeds the threshold value. In an embodiment, if threshold validator 1908 determines that the calculated trust score does not meet the minimum threshold value, the connection request will be denied. At step 2210, connection request processing components 200 establish a carpool with the first user and the second user if the calculated trust score exceeds the minimum threshold value.

In an embodiment, method 2200 may further comprise storing carpooling connection data in a connections database, retrieving the carpooling connection data from the connections database, and using the retrieved carpooling connection data to establish a second carpooling connection in response to a connection request between the first user and the second user.

The particular processing operations and other system functionality described in conjunction with the flow diagrams of FIGS. 3-4, 6-7, 9-10, 12, 17, and 20-22 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the processes of FIGS. 3-4, 6-7, 9-10, 12, 17, and 20-22 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

FIGS. 1A through 22 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

### EXAMPLES

The following examples illustrate how the various modules of the present invention are practically integrated and how their interdependent data flows are managed to provide a secure, reliable, and user-friendly carpooling platform.

### Example 1: Integration of Connection Management, Group Discovery, Ride Coordination, and Privacy Control

In an embodiment, a user initiates a carpooling connection by submitting a connection request via the mobile application interface. The request is first received by the connection management module (FIGS. 2-4), wherein the Request Processing Unit validates the input data and verifies the user's identity using secure authentication protocols (e.g., multi-factor authentication). Upon successful verification, the system calculates an initial trust score based on the user's connection history and other relevant parameters as defined in the Trust Score Calculation Framework (FIGS. 18-21). Concurrently, the Group Discovery Engine (FIGS. 8-10) assesses the user's geographic location using real-time geofencing data and, based on pre-defined boundaries, automatically assigns the user to an appropriate location-based group. Minimal user information (e.g., name and icon) is then made visible to other group members through the Member Visibility Controller. Once a mutual carpooling connection is established through the connection management module (as verified by the mutual approval process), the ride coordination module (FIGS. 5-7) is enabled. At this stage, the driver initiates a ride creation request, which is validated against the established connection network. The Ride Coordination Engine then cross-references the participating users' trust scores and group affiliations to ensure compliance with the predetermined thresholds. Before ride details are communicated, the Privacy Control Module (FIGS. 5-7, 14) enforces role-based information access, ensuring that only authorized data is transmitted via encrypted channels. Thus, the integrated operation of the connection management, group discovery, ride coordination, and privacy control modules ensures a secure and efficient carpooling experience.

### Example 2: Error Handling and Rollback in Inter-Module Integration

In an embodiment, consider a scenario in which a discrepancy is detected during the synchronization of ride status updates between the Ride Coordination Module (FIGS. 5-7) and the Connection Management Module (FIGS. 1B-2). Suppose that, during a routine real-time update, the Status Synchronization Engine identifies a mismatch in the connection state of a participating user-such as an unexpected change in the user's connection approval status not reflected in the group membership records. Upon detection of this anomaly, the system triggers the Error Propagation and Rollback Procedures as defined in the Inter-Module Integration Architecture. Specifically, the affected module immediately generates an error code that is transmitted via the central event bus to all interconnected modules, including the Group Discovery Engine and the Privacy Control Module. Each module then initiates an atomic rollback mechanism, reverting to the most recent consistent state as logged in the Versioned Transaction Logs (FIG. 13). If the error persists beyond a predetermined number of reconciliation attempts (e.g., three consecutive failures), the Administrative Monitoring System (FIG. 15) automatically escalates the issue by issuing an administrative alert and activating the safe fallback mode, thereby temporarily isolating the affected modules from further state changes while maintaining minimal functionality. This embodiment demonstrates how integrated error handling and rollback processes ensure system integrity and continuity of service, even in the event of inter-module discrepancies.

### Example 3: Horizontal Scaling Methodology

The system implements auto-scaling through Kubernetes clusters (FIG. 1B) with:
Regional node groups scaling 50-500 pods based on QPS
Redis Cluster sharding with 64-512 virtual slots
Spanner instance scaling from 1-100 nodes at 200 ms latency SLA
Load balancing using weighted least connections algorithm.

### Example 4: Failure Recovery Protocol

During node failure detection (FIG. 15, System Health Monitor 1522):
1. Initiate 3-phase commit protocol abort
2. Redirect traffic to nearest healthy region within 150 ms
3. Rebuild state from WAL logs using LSN sequencing
4. Validate Merkle tree root hash consistency
5. Resume operations with <50 ms service degradation

### Example 5: Dynamic Geofencing Adjustment Protocol

When detecting stadium event dispersal patterns (FIGS. 8-9, Boundary Calculator 806):
1. Ingest real-time traffic APIs (weight: 0.6) and public transit alerts (weight: 0.4)
2. Compute optimal geofence vertices using:
   def adjust_geofence(base_polygon, traffic_data): buffer_radius=max(500 m, 0.2*avg_speed(mph)*120) return voronoi_overlay(base_polygon).buffer(buffer_radius)
3. Activate emergency protocols if road closures>25% perimeter:
   Expand boundaries using Dijkstra's pathfinding
   Override normal privacy rules for safety alerts
   Initiate cache invalidation cascade (TTL: 8 s)
4. Update member devices via differential boundary patches (Δencoding)

### Example 6: Cryptographic Key Rotation Implementation

The system implements automated key rotation through:
1. HSM-protected master key (RSA-4096) generates monthly DEKs
2. Key distribution protocol:

```
    public void rotateKeys( ) {
  Key newDEK = HSM.generateKey(AES_256);
  byte[ ] encryptedDEK = encryptWithMasterKey(newDEK);
  ledger.write(new KeyRecord(LocalDateTime.now( ), encryptedDEK));
  triggerKeyPropagation(newDEK);
}
```

3. Client-side implementation:
   Grace period: 72 hrs for key transition
   Automated expiration of old encrypted blobs
   OCSP checks for revoked certificates
4. Security monitoring:
   Alert if >3% nodes fail rotation
   Forced re-encryption if latency exceeds 200 ms

### Example 7: Distributed Ledger Conflict Resolution

When detecting node version divergence (FIGS. 16-17):
1. Initiate Byzantine Fault Tolerance consensus:
   Require ⅔ node agreement threshold
   Validate timestamps against NTP-synced atomic clocks
2. Conflict resolution matrix:

| Conflict Type | Resolution Protocol | Timeout |
|---|---|---|
| Driver State Conflict | Latest verified GPS coordinates | 150 ms |
| Passenger Membership | Majority node agreement | 300 ms |
| Payment Discrepancy | Blockchain oracle verification | 500 ms |

3. Fallback procedure:
   Freeze state changes during resolution
   Maintain WAL logs with LSN sequencing
   Validate Merkle tree root hashes pre-commit

### Example 8: GDPR Compliance Implementation

When user invokes “Right to Be Forgotten”:
1. Data identification phase:
   Query distributed ledger for all data shards
   Cross-reference with Cassandra event logs
2. Secure erasure process:
   DELETE FROM user_data
WHERE user_id=: id
APPLY BATCH
WITH CONSISTENCY LEVEL ALL;
3. Third-party coordination:
   API calls to payment processors (Stripe/PayPal)
   Blockchain tombstone transactions
   CDN purge requests (Akamai/Fastly)
4. Post-erasure verification:
   Statistical sampling of 15% data stores
   Generate SHA-256 proof-of-deletion bundles

### Example 9: Real-Time Threat Detection

The ML anomaly detection system:
1. Feature extraction pipeline:
   Connection attempt frequency (Z-score threshold: 2.5° C.)
   Geospatial velocity (max 75 mph between consecutive logins)
   Group join/leave patterns (entropy analysis)
2. Model architecture:

```
model = Sequential([
  LSTM(128, input_shape=(60, 15)), # 60 timesteps, 15 features
  Dropout(0.4),
  Dense(64, activation=‘relu’),
  Dense(1, activation=‘sigmoid’)
])
```

3. Automated response triggers:
   Level 1: Session termination+MFA challenge
   Level 2: Account freeze+connection graph analysis
   Level 3: Geographic lockdown of associated groups

### Example 10: Multi-Region Failover Protocol

During regional outage detection:
1. Traffic rerouting:
   503 ms latency threshold for failover initiation
   Global Server Load Balancer updates (max 45 s propagation)
2. Data synchronization:
   DynamoDB global tables (last-writer-wins with vector clocks)
   Conflict-free replicated data types (CRDTs) for group states
3. Cryptographic re-establishment:
   Replicate HSM clusters across 3 regions
   Session key renegotiation via ECDHE_RSA (P-384)
4. Post-failover reconciliation:
   Differential state merging (rsync algorithm variant)
   Audit trail verification against Write-Ahead Logs

1. Non-transitory computer-readable media comprising program code that when executed by a programmable processor causes execution of a method for secure carpooling, the computer readable media comprising:
computer program code for storing a group relational database comprising a plurality of database schema including at least a user profile schema storing profile data about a plurality of users, a connection management schema storing connection relationship data between the plurality of users, and a group membership registry schema storing group data representing one or more groups to which each of the plurality of users is a member;
computer program code for optimizing query performance in the group relational database;
computer program code for receiving, over a secure communication channel, a carpool request from a first user having a profile record in the user profile schema;
computer program code for querying the group relational database to identify a second user having a connection to the first user in the connection management schema;
computer program code for sending a carpool request invitation to the second user identified from the query;
computer program code for retrieving, from the user profile schema, data for the first user and the second user;
computer program code for calculating a trust score for the first user and the second user using the data, the trust score being private and calculated based on a weighted formula combining one or more trust factors;
computer program code for determining that the calculated trust score exceeds a minimum threshold value; and
computer program code for establishing a carpool between the first user and the second user if the calculated trust score exceeds the minimum threshold value.

2. The non-transitory computer-readable media of claim 1, wherein the one or more trust factors comprise a connection frequency analysis, group membership volatility, event participation patterns, and historical verification irregularities.

3. The non-transitory computer-readable media of claim 1, wherein each of the one or more trust factors is assigned a relative weight value.

4. The non-transitory computer-readable media of claim 1 further comprising computer program code for:
continuously updating the data stored in the user profile schema;
retrieving the updated data; and
recalculating the trust score in response to a change in the updated data or an elapsing of a predetermined amount of time.

5. The non-transitory computer-readable media of claim 1, wherein the carpooling connection is established using end-to-end data encryption.

6. The non-transitory computer-readable media of claim 1 further comprising computer program code for:
identifying a security threat using real-time usage analytics and anomaly detection algorithms; and
mitigating the identified security threat according to a predefined response protocol.

7. The non-transitory computer-readable media of claim 1 further comprising computer program code for:
calculating a trust score for a driver, the trust score being calculated based on a weighted formula combining one or more driver trust factors;
determining that the calculated trust score exceeds a minimum threshold value; and
establishing a carpooling connection between the first user, the second user, and the driver if the calculated trust score exceeds the minimum threshold value.

8. The non-transitory computer-readable media of claim 1 further comprising computer program code for:
creating, using real-time geofencing data, location-based groups;
providing access to a given location-based group based on a current location of a user;
displaying information regarding the given location-based group to the user, the information comprising a name of and an icon for the given location-based group;
storing the location-based groups in the group relational database;
receiving updated geofencing data; and
updating the group membership registry schema with data representing membership of the location-based groups based on the updated geofencing data.

9. The non-transitory computer-readable media of claim 1 further comprising computer program code for:
creating, using real-time user activity data, interest-based groups;
providing access to a given interest-based group based on an affiliation of a user;
displaying information regarding the given interest-based group to the user, the information comprising a name of and an icon for the given interest-based group;
storing the interest-based groups in the group relational database;
receiving updated user activity data; and
updating the group membership registry schema with data representing membership of the interest-based groups based on the updated user activity data.

10. The non-transitory computer-readable media of claim 1 further comprising computer program code for implementing a driver approval mechanism wherein a driver provides an approval to establish a carpooling connection with the first user and the second user.

11. The non-transitory computer-readable media of claim 1 further comprising computer program code for implementing a mutual approval mechanism wherein the first user and the second user each provide an approval to establish the carpooling connection.

12. The non-transitory computer-readable media of claim 1 further comprising computer program code for:
storing carpooling connection data in the group relational database;
retrieving the carpooling connection data from the group relational database; and
using the retrieved carpooling connection data to establish a second carpooling connection in response to a connection request between the first user and the second user.

13. A method for secure carpooling, the method performed by at least one processor comprising hardware, the method comprising:
storing a group relational database comprising a plurality of database schema stored to optimize query performance, the database schema including at least a user profile schema storing profile data about a plurality of users, a connection management schema storing connection relationship data between the plurality of users, and a group membership registry schema storing group data representing one or more groups to which each of the plurality of users is a member;
receiving, over a secure communication channel, a carpool request from a first user having a profile record in the user profile schema;
querying the group relational database to identify a second user having a connection to the first user in the connection management schema;
sending a carpool request invitation to the second user identified from the query;
retrieving, from the user profile schema, data for the first user and the second user;
calculating a trust score for the first user and the second user using the data, the trust score being private and calculated based on a weighted formula combining one or more trust factors;
determining that the calculated trust score exceeds a minimum threshold value; and
establishing a carpool between the first user and the second user if the calculated trust score exceeds the minimum threshold value.

14. The method of claim 13, wherein the one or more trust factors comprise a connection frequency analysis, group membership volatility, event participation patterns, and historical verification irregularities.

15. The method of claim 13, wherein each of the one or more trust factors is assigned a relative weight value.

16. The method of claim 13, the method further comprising:
continuously updating the data stored in the user profile schema;
retrieving the updated data; and
recalculating the trust score in response to a change in the updated data or an elapsing of a predetermined amount of time.

17. The method of claim 13, the method further comprising:
identifying, by an administrative trust validation module, a security threat using real-time usage analytics and anomaly detection algorithms; and
mitigating, by the administrative trust validation module, the identified security threat according to a predefined response protocol.

18. The method of claim 13, the method further comprising:
calculating a trust score for a driver, the trust score being calculated based on a weighted formula combining one or more driver trust factors;
determining that the calculated trust score exceeds a minimum threshold value; and
establishing a carpooling connection between the first user, the second user, and the driver if the calculated trust score exceeds the minimum threshold value.

19. The method of claim 13, the method further comprising implementing a driver approval mechanism wherein a driver provides an approval to establish a carpooling connection with the first user and the second user.

20. The method of claim 13, the method further comprising implementing a mutual approval mechanism wherein the first user and the second user each provide an approval to establish the carpooling connection.
